(19) United States
(12) Patent Application Publication
(10) Pub. No.: US 2022/0334302 A1
(43) Pub. Date: Oct. 20, 2022

(54) IN SITU CORE-SHELL NANOPARTICLE PREPARATION

(71) Applicant: Meta Platforms Technologies, LLC, Menlo Park, CA (US)

(72) Inventors: Keren ZHANG, Woodinville, WA (US); Sara AZARI, Kirkland, WA (US); Feyza DUNDAR ARISOY, Redmond, WA (US); Ankit VORA, Bothell, WA (US)

(21) Appl. No.: 17/720,083

(22) Filed: Apr. 13, 2022

Related U.S. Application Data
(60) Provisional application No. 63/175,373, filed on Apr. 15, 2021.

(51) Int. Cl. F21V 8/00; G02B 27/01; C08K 3/22; B05D 3/06; B05D 3/02; B05D 5/06

(52) U.S. Cl. CPC G02B 6/0038; G02B 27/0172; C08K 3/22; B05D 3/067; B05D 3/0254; B05D 5/061; G02B 2027/0123; C08K 2003/2237; C08K 2003/221

(57) ABSTRACT

An optical device includes a substrate, a surface-relief grating including grooves and ridges formed on or in the substrate, and an overcoat layer in the grooves of the surface-relief grating. The ridges of the surface-relief grating or the overcoat layer includes a plurality of clusters of metal oxide (e.g., TiO₂ or NbOₓ) nanoparticles. Each cluster of the plurality of clusters of metal oxide nanoparticles includes metal oxide nanoparticles dispersed in an inorganic barrier that isolates the metal oxide nanoparticles from other materials of the optical device. The ridges of the surface-relief grating or the overcoat layer is made of a resin material that includes a resin with inorganic content, and/or TiOₓ or NbOₓ nanoparticles including inorganic-containing ligands. A high-energy treatment process can remove organics surrounding the metal oxide nanoparticles and form the barrier layers that surround clusters of metal oxide nanoparticles.

### CROSS-REFERENCE TO RELATED APPLICATIONS

This application claims the benefit of and priority to U.S. Provisional Application No. 63/175,373, filed Apr. 15, 2021, entitled “IN SITU CORE-SHELL NANOPARTICLE PREPARATION,” which is herein incorporated by reference in its entirety for all purposes.

### BACKGROUND

An artificial reality system, such as a head-mounted display (HMD) or heads-up display (HUD) system, generally includes a near-eye display (e.g., in the form of a headset or a pair of glasses) configured to present content to a user via an electronic or optic display within, for example, about 10-20 mm in front of the user's eyes. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by, for example, seeing through transparent display glasses or lenses (often referred to as optical see-through).

One example of an optical see-through AR system may use a waveguide-based optical display, where light of projected images may be coupled into a waveguide (e.g., a transparent substrate), propagate within the waveguide, and be coupled out of the waveguide at different locations. In some implementations, the light of the projected images may be coupled into or out of the waveguide using diffractive optical elements, such as surface-relief gratings or volume Bragg gratings. Light from the surrounding environment may pass through a see-through region of the waveguide and reach the user's eyes as well.

### SUMMARY

This disclosure relates generally to surface-relief gratings. More specifically, disclosed herein are techniques for forming low-loss, high-refractive index surface-relief gratings or overcoat layers of surface-relief gratings. Various inventive embodiments are described herein, including devices, systems, methods, processes, materials, compositions, mixtures, and the like.

According to certain embodiments, an optical device may include a substrate, a surface-relief grating including grooves and ridges formed on or in the substrate, and an overcoat layer in the grooves of the surface-relief grating. The ridges of the surface-relief grating or the overcoat layer may include a plurality of clusters of metal oxide (e.g., TiO₂ or NbOₓ) nanoparticles. Each cluster of the plurality of clusters of metal oxide nanoparticles includes TiO₂ or NbOₓ nanoparticles dispersed in an inorganic barrier that isolates the TiO₂ or NbOₓ nanoparticles from other materials of the optical device.

In some embodiments, the inorganic barrier may include Al₂O₃, SiO₂, ZrO₂, Nb₂O₅, Ta₂O₅, or a combination thereof. The ridges of the surface-relief grating or the overcoat layer may be characterized by a refractive index greater than 1.9 for visible light. A total optical absorption of the surface-relief grating and the overcoat layer may be lower than 0.1% for visible light. Metal oxide nanoparticles of the plurality of clusters of metal oxide nanoparticles may be characterized by linear dimensions less than 16 nm, such as between about 10 nm and about 15 nm. The other materials of the optical device may include organic materials. A cluster of the plurality of clusters of metal oxide nanoparticles may include at least two metal oxide nanoparticles physically contacting each other. In some embodiments, the substrate may include a waveguide, and the surface-relief grating may be configured to couple visible light into or out of the waveguide.

According to certain embodiments, a resin material may include an organic solvent, an organic solvent soluble resin, and TiOₓ or NbOₓ nanoparticles. In some embodiments, the organic solvent soluble resin may include inorganic content. In some embodiments, the TiOₓ or NbOₓ nanoparticles may include inorganic-containing ligands. In some embodiments, both the organic solvent soluble resin includes inorganic content and the TiOₓ or NbOₓ nanoparticles include inorganic-containing ligands.

In some embodiments, the organic solvent may include propylene glycol methyl ether acetate (PGMEA), dipropylene glycol methyl ether (DPGME)/tripropylene glycol monomethyl ether (TPM), or a solvent blend. The organic solvent soluble resin may include acrylate, polystyrenics, epoxy, siloxane, silane, or a combination thereof. The inorganic content of the organic solvent soluble resin may include Si, Zr, Nb, Al, Ta, or a combination thereof. The resin material may also include a photo radical generator or thermal radical generator. The inorganic-containing ligands may include a capping agent or a functionalized ligand, and include Si, Zr, Nb, Al, Ta, or a combination thereof. In some embodiments, the resin material may include 75% by weight to 90% by weight of TiOₓ nanoparticles.

According to certain embodiments, a method may include depositing, on a substrate or a surface-relief grating, a layer of a resin material that includes an organic solvent, a resin soluble in the organic solvent, and metal oxide nanoparticles (e.g., TiOₓ or NbOₓ nanoparticles). In some embodiments, the resin may include inorganic content. In some embodiments, the metal oxide nanoparticles may include inorganic-containing ligands. In some embodiments, the resin may include inorganic content and the metal oxide nanoparticles may include inorganic-containing ligands. The method may also include curing the layer of the resin material using ultraviolet light or heat to crosslink the resin, and performing rapid thermal annealing (RTA) or laser spike annealing (LSA) on the layer of the resin material to remove organics adjacent to the metal oxide nanoparticles and form inorganic barriers for a plurality of clusters of metal oxide nanoparticles, where the inorganic barriers may isolate each cluster of metal oxide nanoparticles of the plurality of clusters of metal oxide nanoparticles from other materials in the layer of the resin material.

In some embodiments, the method may also include imprinting, before the curing, the layer of the resin material to form an imprinted grating in the layer of the resin material, or an overcoat layer having a flat surface. The organic solvent may include propylene glycol methyl ether acetate (PGMEA), dipropylene glycol methyl ether (DPGME)/tripropylene glycol monomethyl ether (TPM), or a solvent blend. The inorganic content of the resin may include Si, Zr, Nb, Al, Ta, or a combination thereof. The inorganic-containing ligands of the metal oxide nanoparticles may include a capping agent or a functionalized ligand that includes Si, Zr, Nb, Al, Ta, or a combination thereof. The resin includes acrylate, polystyrenics, epoxy, siloxane, silane, or a combination thereof.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of an optical see-through augmented reality system including a waveguide display according to certain embodiments.

FIG. 5 illustrates an example of an optical see-through augmented reality system including a waveguide display for exit pupil expansion according to certain embodiments.

FIG. 6 illustrates examples of propagations of display light and external light in an example of a waveguide display.

FIG. 7 illustrates an example of a slanted grating coupler in a waveguide display according to certain embodiments.

FIG. 8A illustrates an example of a waveguide-based near-eye display where display light for all fields of view is substantially uniformly output from different regions of a waveguide display.

FIG. 8B illustrates an example of a waveguide-based near-eye display where display light may be coupled out of a waveguide display at different angles in different regions of the waveguide display according to certain embodiments.

FIG. 9A illustrates an example of a slanted surface-relief grating with variable etch depths according to certain embodiments.

FIG. 9B illustrates an example of a slanted surface-relief grating with variable etch depths and variable duty cycles according to certain embodiments.

FIGS. 10A-10D illustrate an example of a process for fabricating a soft stamp for nanoimprinting according to certain embodiments. FIG. 10A shows a master mold. FIG. 10B illustrates the master mold coated with a soft stamp material layer. FIG. 10C illustrates a lamination process for laminating a soft stamp foil onto the soft stamp material layer. FIG. 10D illustrates a delamination process, where the soft stamp including the soft stamp foil and the attached soft stamp material layer is detached from the master mold.

FIGS. 11A-11D illustrate an example of an imprinting process using a soft stamp according to certain embodiments. FIG. 11A shows a waveguide coated with an imprint resin layer. FIG. 11B shows the lamination of the soft stamp onto the imprint resin layer. FIG. 11C shows the delamination of the soft stamp from the imprint resin layer. FIG. 11D shows an example of an imprinted slanted grating formed on the waveguide.

FIGS. 12A-12C illustrate an example of a method of forming a planarized overcoat layer on a surface-relief grating according to certain embodiments.

FIGS. 13A-13B illustrate an example of a method of forming a planarized overcoat layer on a surface-relief grating using inkjet printing and imprinting techniques according to certain embodiments.

FIG. 14A illustrates an example of a waveguide display including surface-relief gratings and overcoat layers.

FIG. 14B illustrates an example of an overcoat layer that includes nanoparticles dispersed in organic materials.

FIG. 15A illustrates an example of the photocatalytic activity of TiO₂ nanoparticles.

FIG. 15B illustrates an example of organic degradation caused by the photocatalytic activity of TiO₂ nanoparticles.

FIGS. 16A-16D illustrate an example of a process of fabricating a waveguide display.

FIG. 16E illustrates changes in the optical losses of examples of waveguide displays including surface-relief gratings having different metal oxide nanoparticles during the fabrication processes.

FIG. 17 illustrates an example of a nanoparticle including an inorganic shell isolating a metal oxide nanoparticle core from surrounding organic materials.

FIG. 18A illustrates an example of a resin material including an inorganic-containing resin and nanoparticles dispersed in the inorganic-containing resin according to certain embodiments.

FIG. 18B illustrates an example of a TiO₂ nanoparticle including inorganic-containing capping agents according to certain embodiments.

FIG. 18C illustrates an example of an annealed resin material including inorganic materials surrounding nanoparticles according to certain embodiments.

FIGS. 19A-19E illustrate an example of a process of fabricating a surface-relief grating including an overcoat layer having a high refractive index and a low loss using the resin material disclosed herein according to certain embodiments.

FIGS. 20A-20E illustrate an example of a process of fabricating a surface-relief grating including grating ridges having a high refractive index and a low loss using the resin material disclosed herein according to certain embodiments.

FIG. 21 includes a flowchart illustrating an example of a process of fabricating a surface-relief grating having a high refractive index contrast and a low loss using the resin material disclosed herein according to certain embodiments.

FIG. 22 is a simplified block diagram of an example electronic system of an example near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to surface-relief gratings. More specifically, disclosed herein are techniques for forming low-loss, high-refractive index surface-relief gratings or overcoat layers of surface-relief gratings. Various inventive embodiments are described herein, including devices, systems, methods, processes, materials, compositions, mixtures, and the like.

Surface-relief gratings may be used in some optical devices to manipulate behavior of light. For example, straight or slanted surface-relief gratings may be used in near-eye display systems to couple display light into or out of display waveguides. An overcoat layer having a refractive index different from the refractive index of grating ridges of a surface-relief grating may be formed on the surface-relief grating to fill the grating grooves and protect the straight or slanted surface-relief gratings. In general, it is desirable to have a large refractive index contrast between the grating ridges and the overcoat layer in the grating grooves to improve, for example, the light coupling efficiency, the field-of-view range, and the wavelength range of the near-eye display system. In some surface-relief gratings, the grating ridges may be made using a high-refractive index nanoimprinting material (e.g., a resin with high-refractive index metal oxide nanoparticles), and an overcoat layer with a low refractive index may be used to achieve the large refractive index contrast. In some surface-relief gratings, the grating ridges may be made of a low-refractive index material (e.g., glass), and an overcoat layer with a high refractive index (e.g., about 2.0 or larger) may be used to achieve the large refractive index contrast. The high-refractive index material for the grating ridges or the overcoat layer may include a resin dispersed with high-refractive index nanoparticles, such as TiO₂ nanoparticles, ZrO₂ nanoparticles, and the like.

TiO₂ has a higher refractive index (e.g., greater than about 2.5 for visible light) than ZrO₂ (e.g., about 2.15 for visible light) and other dielectric materials (e.g., metal oxides such as NbOₓ, LaOₓ, TaOₓ, Al₂O₃, etc.), and thus may be mixed with a resin to form a high-refractive index resin material (e.g., with a refractive index about 2.0 or higher) for nanoimprinting or overcoating. However, high-refractive index resin materials, such as mixtures including organics mixed with TiO₂ particles, may have high absorption in visible wavelengths, and the absorption may increase during the fabrication and usage of the devices (e.g., near-eye displays) made of these high-refractive index resin materials. For example, due to the photo-activity of titanium oxide, TiO₂ nanoparticles exposed to ultraviolet (UV) light may interact with moisture and/or oxygen to generate radicals (e.g., hydroxyl radicals) that may oxidize and degrade organics (e.g., ligands and resin) in the high-refractive index resin materials, where the degraded organics may absorb visible light. These interactions may also be thermally induced, in addition to photoexcitation. Due to their high surface-volume ratios, TiO₂ nanoparticles may have high light absorption rates, which may increase the surface photo-induced carrier density that can lead to higher surface photoactivity and enhanced photocatalytic activity of TiO₂ nanoparticles. As a result, films including titanium oxide nanoparticles and organics may show some levels of light absorption in the visible spectrum. The absorption of the films may increase over time, as the films undergo further redox interactions with their environment, such as upon exposure to UV light and/or heat. Surface-relief gratings and/or overcoat layers made of the high-absorption films may lead to high loss and low throughput for waveguide displays.

Nanoparticles with metal oxide nanoparticle cores and inorganic shells (referred to as core-shell nanoparticles) may be synthesized and mixed with a resin to form a high-refractive index, low-optical loss resin material for nanoimprinting or overcoating. Each nanoparticle may include an inorganic shell surrounding the nanoparticle core (e.g., a TiO₂ nanoparticle) and isolating the nanoparticle core from organic ligands and/or resin, such that electrons and holes generated by TiO₂ upon exposure to UV light or heat may recombine before the electrons and holes could reach the organic ligands and/or resin to degrade the organic materials. Using core-shell nanoparticles may reduce the optical loss of the surface-relief grating caused by the photocatalytic activity of TiO₂ nanoparticles, but it is challenging to chemically synthesize core-shell nanoparticles with controlled sizes. Multiple synthesis and purification processing steps may generally be needed to make the core-shell nanoparticles, which may increase the cost. The dispersibility of chemically synthesized core-shell nanoparticles may be low. The shelf life of chemically synthesized core-shell nanoparticles may be short, and the shell material may nucleate by itself. It may also be challenging to control the shell thickness, which may affect the refractive index, photocatalytic activity, or other properties of the nanoparticles. The core-shell nanoparticles may be much larger than the nanoparticle cores, and thus it can be harder to pack and gap-fill using the larger core-shell nanoparticles.

According to certain embodiments, nanoparticle cores (e.g., TiO₂ nanoparticles) with inorganic barriers may be formed in situ in a resin material after the deposition of the resin material, rather than being pre-synthesized into core-shell nanoparticles before mixing the core-shell nanoparticles with a resin and a solvent. In one example, metal oxide nanoparticles (e.g., TiO₂ nanoparticles) may be dispersed in an inorganic-containing resin (e.g., having high Si, Zr, Nb, and/or Al content) to form a resin material for imprinting surface-relief gratings or overcoating the surface-relief gratings. In another example, the metal oxide nanoparticles in a resin material may include inorganic-containing capping agents/ligands formed thereon. The resin material including the inorganic-containing resin or the nanoparticles with inorganic-containing capping agents/ligands may be deposited on a substrate or a surface-relief grating, optionally imprinted, crosslinked, and then annealed by, for example, rapid thermal annealing (RTA) or laser spike annealing (LSA), to remove organics in the inorganic-containing capping agents/ligands or the inorganic-containing resin surrounding the nanoparticles, and form inorganic barriers that surround each cluster of nanoparticles to isolate the nanoparticles from organic materials and other materials in the resin material or the environment, thereby sequestering the photocatalytic activity of the TiO₂ nanoparticles.

In one example, a resin material may include an organic solvent; an organic solvent soluble resin with high Si, Zr, Nb, Al, and/or Ta content; and TiOₓ nanoparticles mixed with the organic solvent soluble resin and the solvent. The organic solvent may include, for example, propylene glycol methyl ether acetate (PGMEA) (for spin-on coating), dipropylene glycol methyl ether (DPGME)/tripropylene glycol monomethyl ether (TPM) (for inkjet coating), or a solvent blend including one or more solvents that may or may not have boiling points greater than 200° C. The organic solvent soluble resin may include, for example, acrylate, polystyrenics, epoxy, siloxane, or silane-containing resin with a photo radical generator or thermal radical generator. The TiOₓ nanoparticles may be about 75% by weight to about 90% by weight of the resin material.

In another example, a resin material may include an organic solvent soluble resin, such as acrylate, polystyrenics, epoxy, siloxane, or silane-containing resin with a photo radical generator or thermal radical generator and having a refractive index between about 1.55 and about 1.7. The resin material may also include about 75% to about 90% of TiOₓ nanoparticles decorated with Si, Zr, Nb, Al, and/or Ta containing capping agents and/or functionalized ligands. The resin material may include a solvent such as PGMEA (for spin-on coating), DPGME/TPM (for inkjet coating), or a solvent blend including one or more solvents that may or may not have boiling points greater than 200° C.

Compared with chemically synthesized core-shell nanoparticles that may have larger sizes, nanoparticles with inorganic barriers formed in situ may achieve a better packing of nanoparticles, and thus may achieve higher refractive indices, better gap fill, and lower surface roughness. The shell thickness can be tuned by tuning the type of capping agent and/or resin. Current commercially available metal oxide nanoparticle cores may be used, and the cost of the nanoparticles with inorganic barriers formed in situ may be much lower than chemically synthesized core-shell nanoparticles.

Unless defined otherwise, all technical and scientific terms used herein have the same meaning as is commonly understood by one of ordinary skill in the art to which this disclosure belongs.

As used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of very different sizes, shapes and dimensions may employ the described arrangements.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

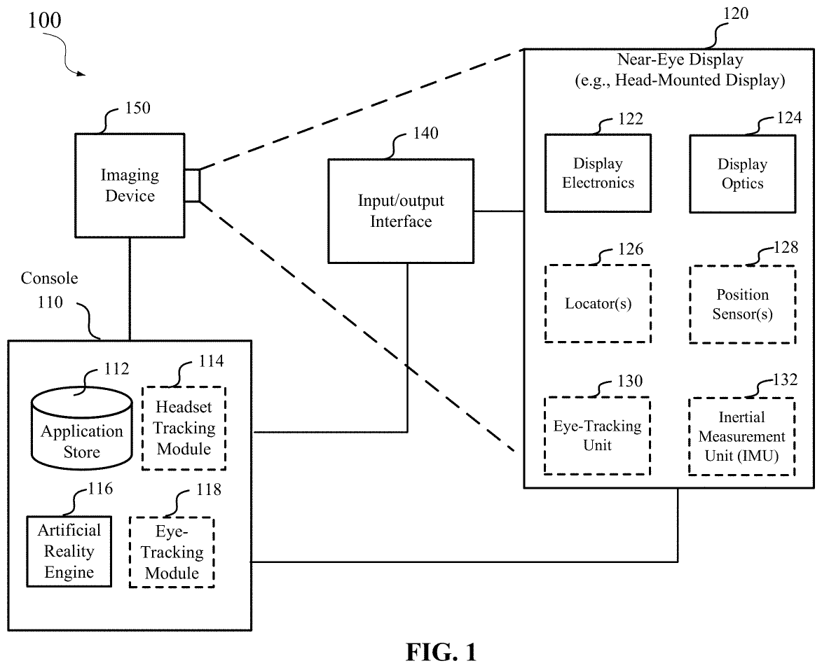

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

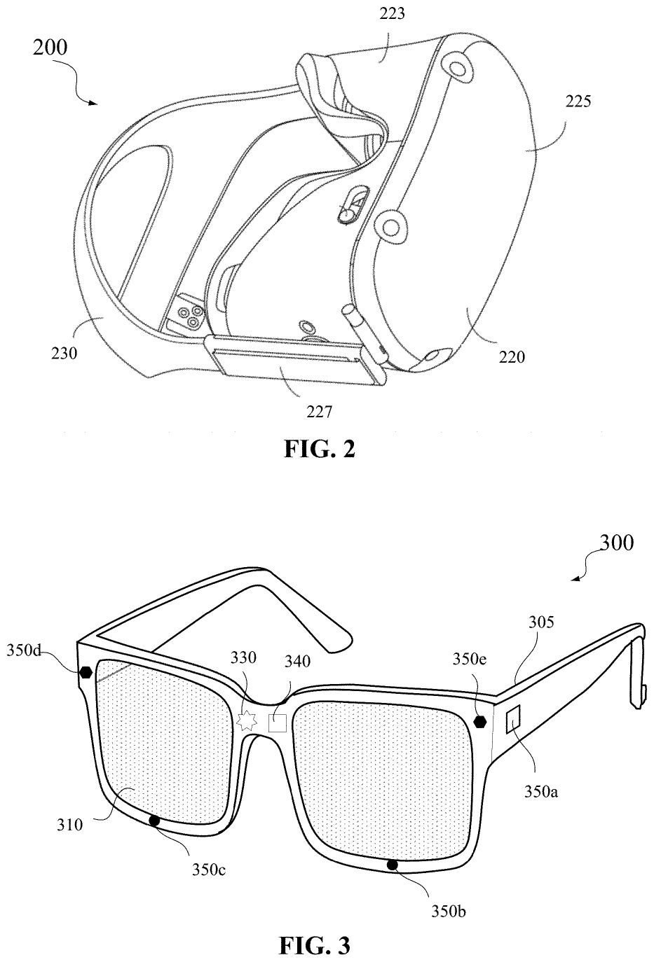

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light-emitting diode (LED), a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 100 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future location of near-eye display 120. Headset tracking module 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking module 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. High-resolution camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

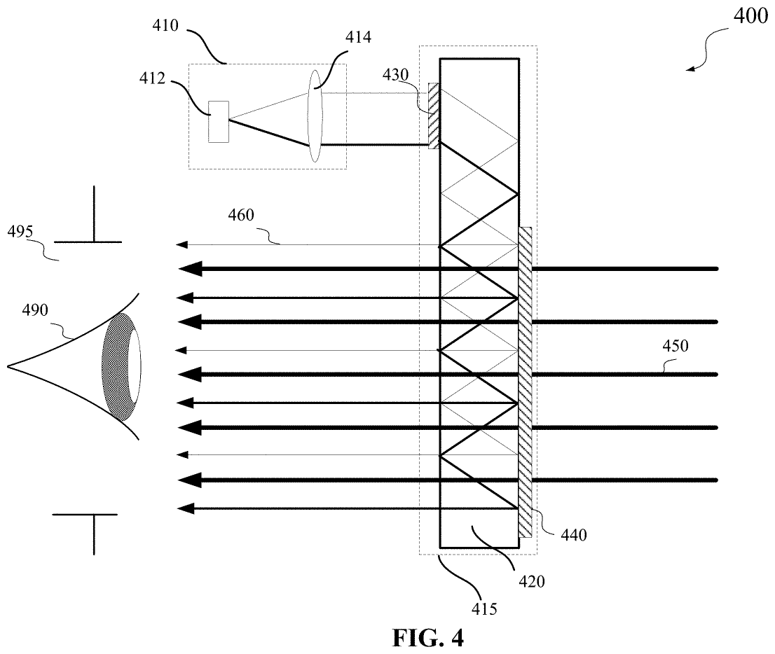

FIG. 4 illustrates an example of an optical see-through augmented reality system 400 including a waveguide display according to certain embodiments. Augmented reality system 400 may include a projector 410 and a combiner 415. Projector 410 may include a light source or image source 412 and projector optics 414. In some embodiments, light source or image source 412 may include one or more micro-LED devices described above. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, an LED, and/or a micro-LED described above. In some embodiments, image source 412 may include a plurality of light sources (e.g., an array of micro-LEDs described above), each emitting a monochromatic image light corresponding to a primary color (e.g., red, green, or blue). In some embodiments, image source 412 may include three two-dimensional arrays of micro-LEDs, where each two-dimensional array of micro-LEDs may include micro-LEDs configured to emit light of a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. For example, in some embodiments, image source 412 may include one or more one-dimensional arrays or elongated two-dimensional arrays of micro-LEDs, and projector optics 414 may include one or more one-dimensional scanners (e.g., micro-mirrors or prisms) configured to scan the one-dimensional arrays or elongated two-dimensional arrays of micro-LEDs to generate image frames. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Combiner 415 may transmit at least 50% of light in a first wavelength range and reflect at least 25% of light in a second wavelength range. For example, the first wavelength range may be visible light from about 400 nm to about 650 nm, and the second wavelength range may be in the infrared band, for example, from about 800 nm to about 1000 nm. Input coupler 430 may include a volume holographic grating, a diffractive optical element (DOE) (e.g., a surface-relief grating), a slanted surface of substrate 420, or a refractive coupler (e.g., a wedge or a prism). For example, input coupler 430 may include a reflective volume Bragg grating or a transmissive volume Bragg grating. Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 10 mm or more. Substrate 420 may be transparent to visible light.

Substrate 420 may include or may be coupled to a plurality of output couplers 440, each configured to extract at least a portion of the light guided by and propagating within substrate 420 from substrate 420, and direct extracted light 460 to an eyebox 495 where an eye 490 of the user of augmented reality system 400 may be located when augmented reality system 400 is in use. The plurality of output couplers 440 may replicate the exit pupil to increase the size of eyebox 495 such that the displayed image is visible in a larger area. As input coupler 430, output couplers 440 may include grating couplers (e.g., volume holographic gratings or surface-relief gratings), other diffraction optical elements, prisms, etc. For example, output couplers 440 may include reflective volume Bragg gratings or transmissive volume Bragg gratings. Output couplers 440 may have different coupling (e.g., diffraction) efficiencies at different locations. Substrate 420 may also allow light 450 from the environment in front of combiner 415 to pass through with little or no loss. Output couplers 440 may also allow light 450 to pass through with little loss. For example, in some implementations, output couplers 440 may have a very low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 in certain desired directions (i.e., diffraction angles) with little loss. As a result, the user may be able to view combined images of the environment in front of combiner 415 and images of virtual objects projected by projector 410.

In some embodiments, projector 410, input coupler 430, and output coupler 440 may be on any side of substrate 420. Input coupler 430 and output coupler 440 may be reflective gratings (also referred to as reflective gratings) or transmissive gratings (also referred to as transmissive gratings) to couple display light into or out of substrate 420.

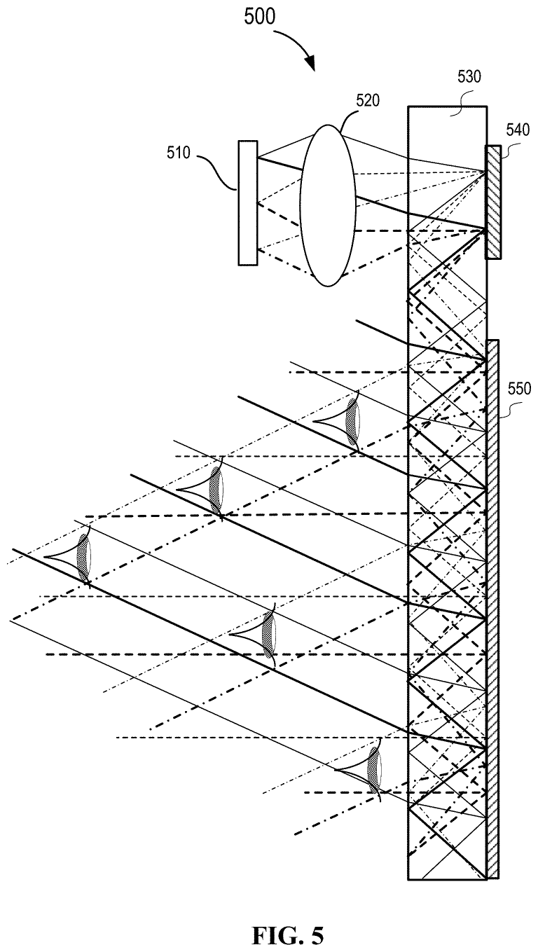

FIG. 5 illustrates an example of an optical see-through augmented reality system 500 including a waveguide display for exit pupil expansion according to certain embodiments. Augmented reality system 500 may be similar to augmented reality system 500, and may include the waveguide display and a projector that may include a light source or image source 510 and projector optics 520. The waveguide display may include a substrate 530, an input coupler 540, and a plurality of output couplers 550 as described above with respect to augmented reality system 500. While FIG. 5 only shows the propagation of light from a single field of view, FIG. 5 shows the propagation of light from multiple fields of view.

FIG. 5 shows that the exit pupil is replicated by output couplers 550 to form an aggregated exit pupil or eyebox, where different regions in a field of view (e.g., different pixels on image source 510) may be associated with different respective propagation directions towards the eyebox, and light from a same field of view (e.g., a same pixel on image source 510) may have a same propagation direction for the different individual exit pupils. Thus, a single image of image source 510 may be formed by the user's eye located anywhere in the eyebox, where light from different individual exit pupils and propagating in the same direction may be from a same pixel on image source 510 and may be focused onto a same location on the retina of the user's eye. FIG. 5 shows that the image of the image source is visible by the user's eye even if the user's eye moves to different locations in the eyebox.

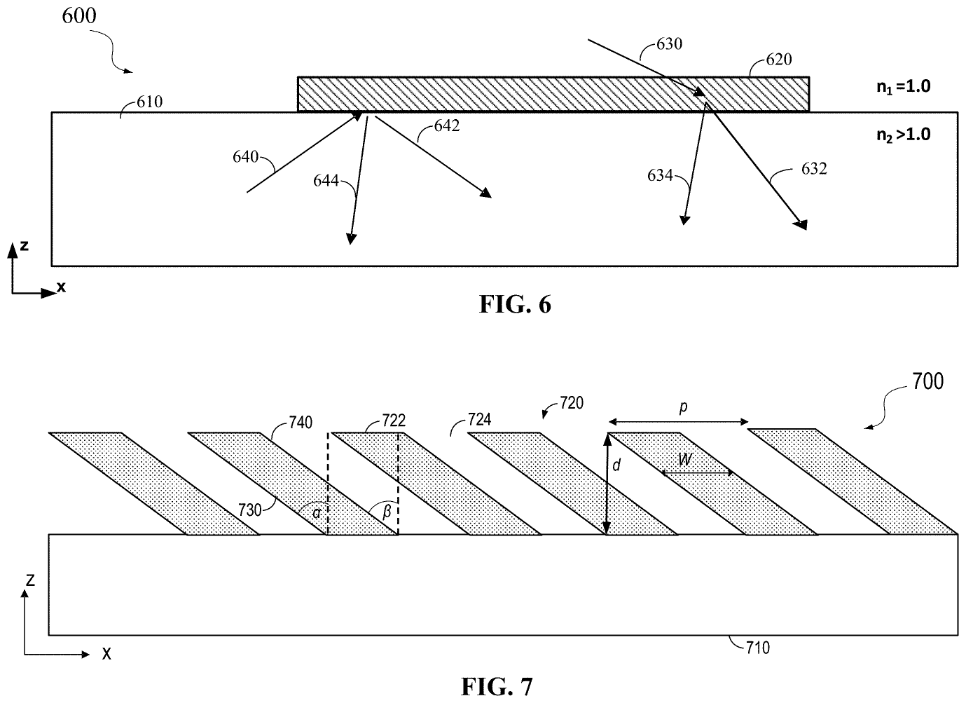

FIG. 6 illustrates propagations of display light 640 and external light 630 in an example waveguide display 600 including a waveguide 610 and a grating coupler 620. Waveguide 610 may be a flat or curved transparent substrate with a refractive index n₂ greater than the free space refractive index m (e.g., 1.0). Grating coupler 620 may be, for example, a Bragg grating or a surface-relief grating.

Display light 640 may be coupled into waveguide 610 by, for example, input coupler 430 of FIG. 4 or other couplers (e.g., a prism or slanted surface) described above. Display light 640 may propagate within waveguide 610 through, for example, total internal reflection. When display light 640 reaches grating coupler 620, display light 640 may be diffracted by grating coupler 620 into, for example, a 0^{th} order diffraction (i.e., reflection) light 642 and a −1st order diffraction light 644. The 0^{th} order diffraction may propagate within waveguide 610, and may be reflected by the bottom surface of waveguide 610 towards grating coupler 620 at a different location. The −1st order diffraction light 644 may be coupled (e.g., refracted) out of waveguide 610 towards the user's eye, because a total internal reflection condition may not be met at the bottom surface of waveguide 610 due to the diffraction angle.

External light 630 may also be diffracted by grating coupler 620 into, for example, a 0th order diffraction light 632 and a −1st order diffraction light 634. Both the 0^{th} order diffraction light 632 and the −1st order diffraction light 634 may be refracted out of waveguide 610 towards the user's eye. Thus, grating coupler 620 may act as an input coupler for coupling external light 630 into waveguide 610, and may also act as an output coupler for coupling display light 640 out of waveguide 610. As such, grating coupler 620 may act as a combiner for combining external light 630 and display light 640. In general, the diffraction efficiency of grating coupler 620 (e.g., a surface-relief grating coupler) for external light 630 (i.e., transmissive diffraction) and the diffraction efficiency of grating coupler 620 for display light 640 (i.e., reflective diffraction) may be similar or comparable.

In order to diffract light at a desired direction towards the user's eye and to achieve a desired diffraction efficiency for certain diffraction orders, grating coupler 620 may include a blazed or slanted grating, such as a slanted Bragg grating or surface-relief grating, where the grating ridges and grooves may be tilted relative to the surface normal of grating coupler 620 or waveguide 610.

FIG. 7 illustrates an example of a slanted grating 720 in a waveguide display 700 according to certain embodiments. Slanted grating 720 may be an example of input coupler 430, output couplers 440, or grating coupler 620. Waveguide display 700 may include slanted grating 720 on a waveguide 710, such as substrate 420 or waveguide 610. Slanted grating 720 may act as a grating coupler for couple light into or out of waveguide 710. In some embodiments, slanted grating 720 may include a one-dimensional periodic structure with a period p. For example, slanted grating 720 may include a plurality of ridges 722 and grooves 724 between ridges 722. Each period of slanted grating 720 may include a ridge 722 and a groove 724, which may be an air gap or a region filled with a material with a refractive index n_{g2}. The ratio between the width d of a ridge 722 and the grating period p may be referred to as duty cycle. Slanted grating 720 may have a duty cycle ranging, for example, from about 10% to about 90% or greater. In some embodiments, the duty cycle may vary from period to period. In some embodiments, the period p of the slanted grating may vary from one area to another on slanted grating 720, or may vary from one period to another (i.e., chirped) on slanted grating 720.

Ridges 722 may be made of a material with a refractive index of n_{g1}, such as silicon containing materials (e.g., SiO₂, Si₃N₄, SiC, SiOₓN_{y}, or amorphous silicon), organic materials (e.g., spin on carbon (SOC) or amorphous carbon layer (ACL) or diamond like carbon (DLC)), or inorganic metal oxide layers (e.g., TiOₓ, AlOₓ, TaOₓ, HfOₓ, etc.). Each ridge 722 may include a leading edge 730 with a slant angel α and a trailing edge 740 with a slant angle β. In some embodiments, leading edge 730 and trailing edge 740 of each ridge 722 may be parallel to each other. In other words, slant angle α is approximately equal to slant angle β. In some embodiments, slant angle α may be different from slant angle β. In some embodiments, slant angle α may be approximately equal to slant angle β. For example, the difference between slant angle α and slant angle θ may be less than 20%, 10%, 6%, 1%, or less. In some embodiments, slant angle α and slant angle β may range from, for example, about 30° or less to about 70% or larger.

In some implementations, grooves 724 between the ridges 722 may be over-coated or filled with a material having a refractive index n_{g2} higher or lower than the refractive index of the material of ridges 722. For example, in some embodiments, a high refractive index material, such as Hafnia, Titania, Tantalum oxide, Tungsten oxide, Zirconium oxide, Gallium sulfide, Gallium nitride, Gallium phosphide, silicon, and a high refractive index polymer, may be used to fill grooves 724. In some embodiments, a low refractive index material, such as silicon oxide, alumina, porous silica, or fluorinated low index monomer (or polymer), may be used to fill grooves 724. As a result, the difference between the refractive index of the ridges and the refractive index of the grooves may be greater than 0.1, 0.2, 0.3, 0.5, 1.0, or higher.

The user experience with an artificial reality system may depend on several optical characteristics of the artificial reality system, such as the field of view (FOV), image quality (e.g., resolution), size of the eye box of the system (to accommodate for eye and/or head movement), the distance of eye relief, optical bandwidth, and brightness of the displayed image. In general, the FOV and the eye box need to be as large as possible, the optical bandwidth needs to cover the visible band, and the brightness of the displayed image needs to be high enough (especially for optical see-through AR systems).

In a waveguide-based near-eye display, the output area of the display may be much larger than the size of the eyebox of the near-eye display system. The portion of light that may reach a user's eyes may depend on the ratio between the size of the eyebox and the output area of the display, which, in some cases, may be less than 10% for a certain eye relief and field of view. In order to achieve a desired brightness of the displayed image perceived by user's eyes, the display light from the projector or the light source may need to be increased significantly, which may increase the power consumption and cause some safety concerns.

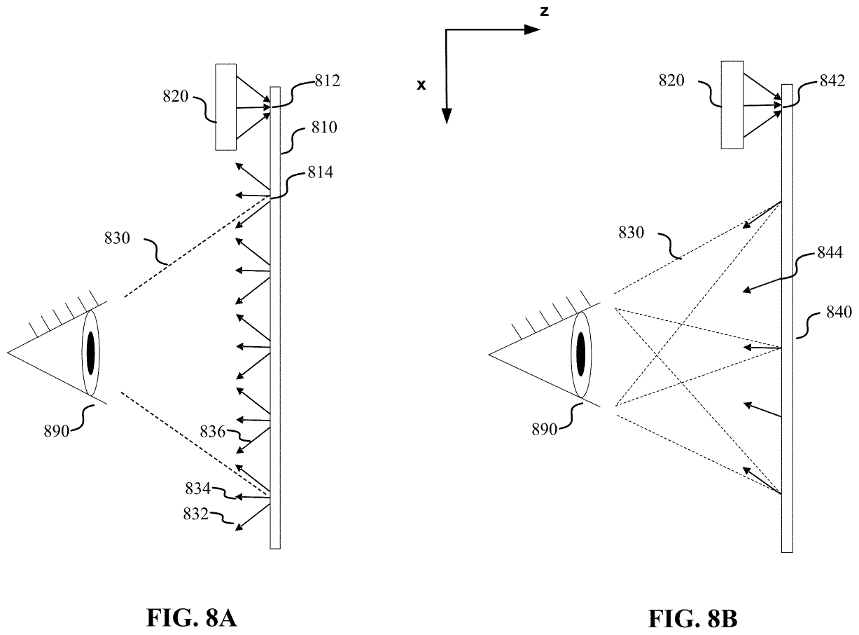

FIG. 8A illustrates an example of a waveguide-based near-eye display where display light for all fields of view is substantially uniformly output from different regions of a waveguide display 810. The near-eye display may include a projector 820 and waveguide display 810. Projector 820 may be similar to projector 410 and may include a light source or image source similar to light source or image source 412 and projector optics similar to projector optics 414. Waveguide display 810 may include a waveguide (e.g., a substrate), one or more input couplers 812, and one or more output couplers 814. Input couplers 812 may be configured to couple display light from different fields of view (or viewing angles) into the waveguide, and output couplers 814 may be configured to couple display light out of the waveguide. The input and output couplers may include, for example, slanted surface-relief gratings or volume Bragg gratings. In the example shown in FIG. 8, output coupler 814 may have similar grating parameters across the full region of the output coupler other than parameters that may be varied to adjust the coupling efficiency for more uniform output light. Thus, the display light may be partially coupled out of the waveguide at different regions of waveguide display 810 in a similar manner as shown in FIG. 8A, where display light from all fields of view of the near-eye display may be partially coupled out of the waveguide at any given region of waveguide display 810.

As also shown in FIG. 8A, the near-eye display system may have an eyebox at a certain eyebox position 890 and having a limited size and thus a limited field of view 830. As such, not all light coupled out of the waveguide in waveguide display 810 may reach the eyebox at eyebox position 890. For example, display light 832, 834, and 836 from waveguide display 810 may not reach the eyebox at eyebox position 890, and thus may not be received by the user's eyes, which may result in significant loss of the optical power from projector 820.

In certain embodiments, an optical coupler (e.g., a slanted surface-relief grating) for a waveguide-based display may include a grating coupler that includes multiple regions (or multiple multiplexed grating), where different regions of the grating coupler may have different angular selectivity characteristics (e.g., constructive interference conditions) for the incident display light such that, at any region of the waveguide-based display, diffraction light that would not eventually reach user's eyes may be suppressed (i.e., may not be diffracted by the grating coupler so as to be coupled into or out of the waveguide and thus may continue to propagate within the waveguide), while light that may eventually reach the user's eyes may be diffracted by the grating coupler and be coupled into or out of the waveguide.

FIG. 8B illustrates an example of a waveguide-based near-eye display where display light may be coupled out of a waveguide display 840 at different angles in different regions of the waveguide display according to certain embodiments. Waveguide display 840 may include a waveguide (e.g., a substrate), one or more input couplers 842, and one or more output couplers 844. Input couplers 842 may be configured to couple display light from different fields of view (e.g., viewing angles) into the waveguide, and output couplers 844 may be configured to couple display light out of the waveguide. The input and output couplers may include, for example, slanted surface-relief gratings or other types of gratings or reflectors. The output couplers may have different grating parameters and thus different angular selectivity characteristics at different regions of the output couplers. Thus, at each region of the output couplers, only display light that would propagate in a certain angular range towards the eyebox at eyebox position 890 of the near-eye display may be coupled out of the waveguide, while other display light may not meet the angular selectivity condition at the region and thus may not be coupled out of the waveguide. In some embodiments, the input couplers may also have different grating parameters and thus different angular selectivity characteristics at different regions of the input couplers, and thus, at each region of an input coupler, only display light from a respective field of view may be coupled into the waveguide. As a result, most of the display light coupled into the waveguide and propagating in the waveguide can be efficiently sent to the eyebox, thus improving the power efficiency of the waveguide-based near-eye display system.

The refractive index modulation of a slanted surface-relief grating, and other parameters of the slanted surface-relief grating, such as the grating period, the slant angle, the duty cycle, the depth, and the like, may be configured to selectively diffract incident light within a certain incident angular range (e.g., FOV) and/or a certain wavelength band at certain diffraction directions (e.g., within an angular range shown by field of view 830). For example, when the refractive index modulation is large (e.g., >0.2), a large angular bandwidth (e.g., >) 10° may be achieved at the output couplers to provide a sufficiently large eyebox for the waveguide-based near-eye display system.

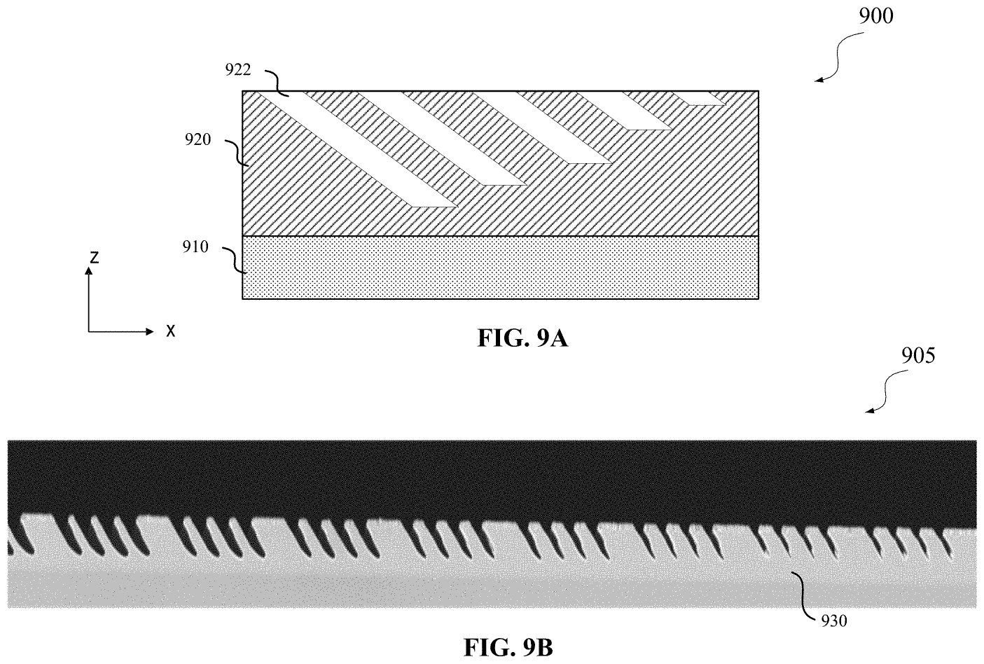

FIG. 9A illustrates an example of a slanted grating 900 with variable etch depths according to certain embodiments. Slanted grating 900 may include a substrate 910 (e.g., a glass substrate) and a grating layer 920 (e.g., a dielectric or polymer layer) formed on substrate 910. A plurality of grating grooves 922 may be etched or otherwise formed (e.g., imprinted) in grating layer 920. Grating grooves 922 may have non-uniform depths, widths, and/or separations. As such, slanted grating 900 may have variable grating periods, depths, and/or duty cycles.

FIG. 9B illustrates an example of a slanted grating 905 with variable etch depths and duty cycles according to certain embodiments. In the example shown in FIG. 9B, slanted grating 905 may be etched in a dielectric layer 930, which may have a refractive index, for example, between about 1.46 and about 2.4. As illustrated, slanted grating 905 may have different etch depths and duty cycles at different regions. The grating period may also be different at the different regions. As such, different regions of slanted grating 905 may have different desire diffraction characteristics as described above with respect to, for example, FIG. 8B.

The surface-relief gratings with parameters and configurations (e.g., duty cycles, depths, or refractive index modulations) varying over the regions of the gratings described above and other surface-relief gratings (e.g., gratings used for eye-tracking) may be fabricated using many different nanofabrication techniques. The nanofabrication techniques generally include a patterning process and a post-patterning (e.g., over-coating) process. The patterning process may be used to form slanted ridges or grooves of the slanted grating. There may be many different nanofabrication techniques for forming the slanted ridges. For example, in some implementations, the slanted grating may be fabricated using lithography techniques including slanted etching. In some implementations, the slanted grating may be fabricated using nanoimprint lithography (NIL) molding techniques, where a master mold including slanted structures may be fabricated using, for example, slanted etching techniques, and may then be used to mold slanted gratings or different generations of soft stamps for nanoimprinting. The post-patterning process may be used to over-coat the slanted ridges and/or to fill the gaps between the slanted ridges with a material having a different refractive index than the slanted ridges. The post-patterning process (e.g., overcoating and planarization) may be independent from the patterning process. Thus, a same post-patterning process may be used on slanted gratings fabricated using any patterning technique.

In a NIL molding process, a substrate (e.g., a waveguide) may be coated with a NIL resin layer. The NIL resin layer may include, for example, a butyl-acrylate-based resin doped with a sol-gel precursor (e.g., titanium butoxide), a monomer containing a reactive functional group for subsequent infusion processes (such as acrylic acid), and/or high refractive index nanoparticles (e.g., titanium oxide, zirconium oxide, hafnium oxide, tungsten oxide, zinc tellurium, or gallium phosphide). In some embodiments, the NIL resin layer may include polydimethylsiloxane (PDMS) or another silicone elastomer or silicon-based organic polymer. The NIL resin layer may be deposited on the substrate by, for example, spin-coating, lamination, or inkjet printing. A NIL mold with a nanostructure formed thereon may be pressed against the NIL resin layer and the substrate for molding a nanostructure in the NIL resin layer. The NIL resin layer may be cured subsequently (e.g., crosslinked) using heat and/or ultraviolet (UV) light. After the curing, the NIL mold may be detached from the NIL resin layer and the substrate. After the NIL mold is detached from the NIL resin layer and the substrate, a nanostructure (e.g., a slanted grating) that is complementary to the nanostructure in the NIL mold may be formed in the NIL resin layer on the substrate.

In some embodiments, a master NIL mold (e.g., a hard mold including a rigid material, such as Si, SiO₂, Si₃N₄, or a metal) may be fabricated first using, for example, slanted etching, micromachining, or 3-D printing. A soft stamp may be fabricated using the master ML mold, and the soft stamp may then be used as the working stamp to fabricate the slanted grating or may be used to fabricate a next generation soft stamp. In such a process, the slanted grating structure in the master ML mold may be similar to the slanted grating of the grating coupler for the waveguide display, and the slanted grating structure on the soft stamp may be complementary to the slanted grating structure in the master ML mold and the slanted grating of the grating coupler for the waveguide display. Compared with a hard stamp or hard mold, a soft stamp may offer more flexibility during the molding and demolding processes.

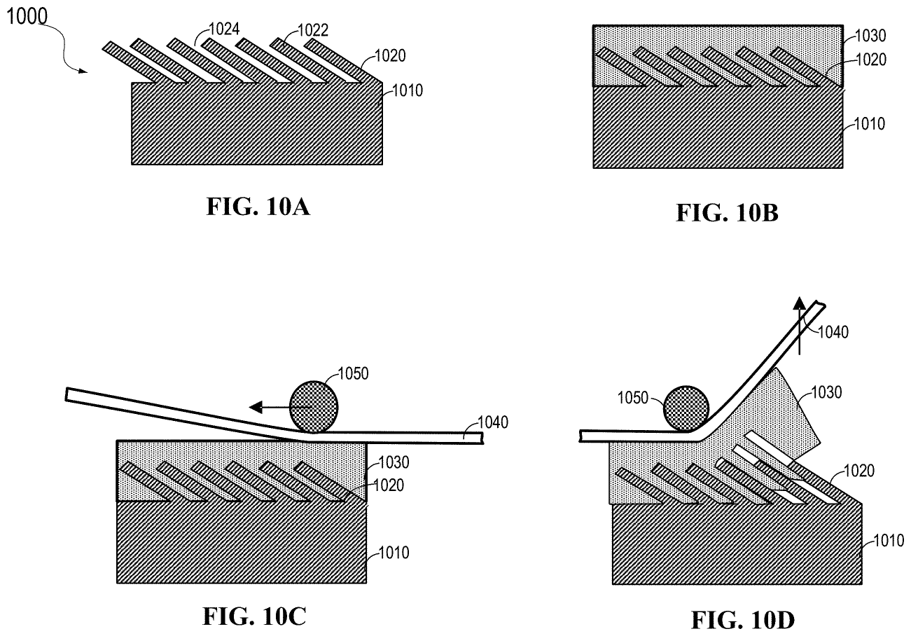

FIGS. 10A-10D illustrate an example of a process 1000 for fabricating a soft stamp for nanoimprinting according to certain embodiments. FIG. 10A shows a master mold 1010 (e.g., a hard mold or hard stamp). Master mold 1010 may include a rigid material, such as a semiconductor substrate (e.g., Si or GaAs), an oxide (e.g., SiO₂, Si₃N₄, TiOₓ, AlOₓ, TaOₓ, or HfOₓ), or a metal plate. Master mold 1010 may be fabricated using, for example, a slanted etching process using reactive ion beams or chemically assisted reactive ion beams, a micromachining process, or a 3-D printing process. As shown in FIG. 10A, master mold 1010 may include a slanted grating 1020 that may in turn include a plurality of slanted ridges 1022 with gaps 1024 (referred to as grooves) between slanted ridges 1022.

FIG. 10B illustrates master mold 1010 coated with a soft stamp material layer 1030. Soft stamp material layer 1030 may include, for example, a resin material or a curable polymer material. In some embodiments, soft stamp material layer 1030 may include polydimethylsiloxane (PDMS) or another silicone elastomer, or a silicon-based organic polymer. In some embodiments, soft stamp material layer 1030 may include ethylene tetrafluoroethylene (ETFE), perfluoropolyether (PFPE), or other fluorinated polymer materials. In some embodiments, soft stamp material layer 1030 may be coated on master mold 1010 by, for example, spin-coating or inkjet printing.

FIG. 10C illustrates a lamination process for laminating a soft stamp foil 1040 onto soft stamp material layer 1030. A roller 1050 may be used to press soft stamp foil 1040 against soft stamp material layer 1030. The lamination process may also be a planarization process to make the thickness of soft stamp material layer 1030 substantially uniform. After the lamination process, soft stamp foil 1040 may be tightly or securely attached to soft stamp material layer 1030.

FIG. 10D illustrates a delamination process, where a soft stamp including soft stamp foil 1040 and attached soft stamp material layer 1030 is detached from master mold 1010. Soft stamp material layer 1030 may include a slanted grating structure that is complementary to the slanted grating structure on master mold 1010. Because the flexibility of soft stamp foil 1040 and attached soft stamp material layer 1030, the delamination process may be relatively easy compared with a demolding process using a hard stamp or mold. In some embodiments, a roller (e.g., roller 1050) may be used in the delamination process to ensure a constant or controlled delamination speed. In some embodiments, roller 1050 may not be used during the delamination. In some implementations, an anti-sticking layer may be formed on master mold 1010 before soft stamp material layer 1030 is coated on master mold 1010. The anti-sticking layer may facilitate the delamination process. After the delamination of the soft stamp from master mold 1010, the soft stamp may be used to mold the slanted grating on a waveguide of a waveguide display.

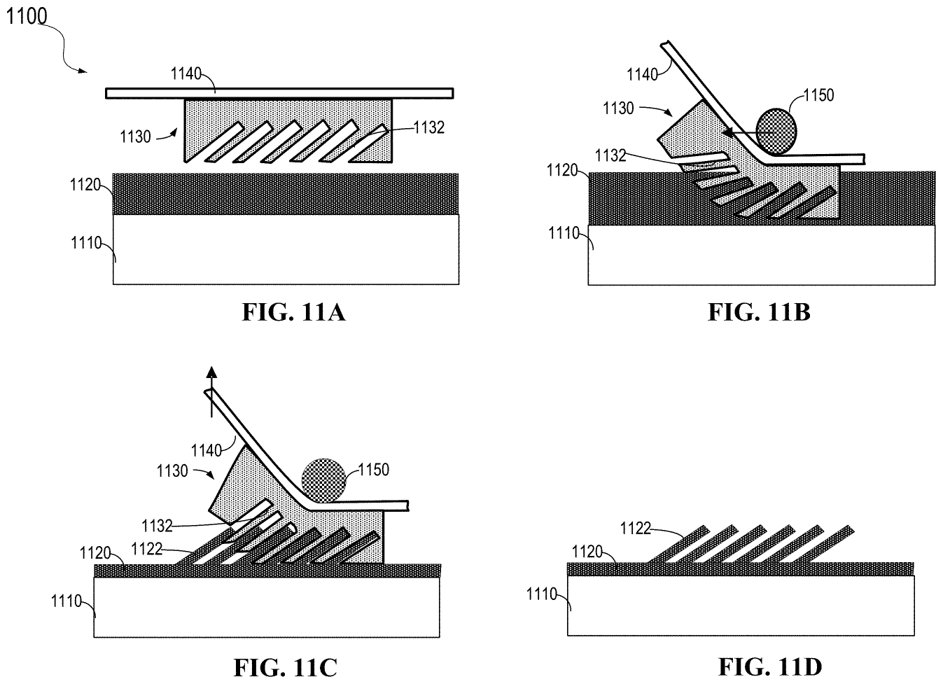

FIGS. 11A-11D illustrate an example of an imprinting process 1100 using a soft stamp according to certain embodiments. FIG. 11A shows a waveguide 1110 coated with an imprint resin layer 1120. Imprint resin layer 1120 may include, for example, a butyl-acrylate based resin doped with a sol-gel precursor (e.g., titanium butoxide), a monomer containing a reactive functional group for subsequent infusion processes (such as acrylic acid), and/or high refractive index nanoparticles (e.g., TiO₂, ZrO₂, GaP, HfO₂, WO₃, GaAs, etc.). In some embodiments, imprint resin layer 1120 may include polydimethylsiloxane (PDMS) or another silicone elastomer, or silicon-based organic polymer. In some embodiments, imprint resin layer 1120 may include ethylene tetrafluoroethylene (ETFE), perfluoropolyether (PFPE), or other fluorinated polymer materials. Imprint resin layer 1120 may be deposited on waveguide 1110 by, for example, spin-coating, lamination, or inkjet printing. A soft stamp 1130 including slanted ridges 1132 attached to a soft stamp foil 1140 may be used for the imprint.

FIG. 11B shows the lamination of soft stamp 1130 onto imprint resin layer 1120. Soft stamp 1130 may be pressed against imprint resin layer 1120 and waveguide 1110 using a roller 1150, such that slanted ridges 1132 may be pressed into imprint resin layer 1120. Imprint resin layer 1120 may be cured subsequently. For example, imprint resin layer 1120 may be crosslinked using heat and/or ultraviolet (UV) light.

FIG. 11C shows the delamination of soft stamp 1130 from imprint resin layer 1120. The delamination may be performed by lifting soft stamp foil 1140 to detach slanted ridges 1132 of soft stamp 1130 from imprint resin layer 1120. Imprint resin layer 1120 may now include a slanted grating 1122, which may be used as the grating coupler or may be over-coated to form the grating coupler for the waveguide display. As described above, because of the flexibility of soft stamp 1130, the delamination process may be relatively easy compared with a demolding process using a hard stamp or mold. In some embodiments, a roller (e.g., roller 1150) may be used in the delamination process to ensure a constant or controlled delamination speed. In some embodiments, roller 1150 may not be used during the delamination.

FIG. 11D shows an example imprinted slanted grating 1122 formed on waveguide 1110 using soft stamp 1130. As described above, slanted grating 1122 may include ridges and grooves between the ridges and thus may be over-coated with a material having a refractive index different from imprint resin layer 1120 to fill the grooves and form the grating coupler for the waveguide display.

The period of the slanted grating may vary from one area to another on slanted grating 1122, or may vary from one period to another (i.e., chirped) on slanted grating 1122. Slanted grating 1122 may have a duty cycle ranging, for example, from about 11% to about 100% or greater. In some embodiments, the duty cycle may vary from period to period. In some embodiments, the depth of the grooves or height of the ridges of slanted grating 1122 may be greater than about 50 nm, about 110 nm, about 200 nm, about 300 nm, about 400 nm, or higher. The slant angles of the leading edges of the ridges of slanted grating 1122 and the slant angles of the trailing edges of the ridges of slanted grating 1122 may be greater than about 30°, about 45°, about 60°, or higher. In some embodiments, the leading edge and training edge of each ridge of slanted grating 1122 may be parallel to each other. In some embodiments, the difference between the slant angle of the leading edge of a ridge of slanted grating 1122 and the slant angle of the trailing edge of the ridge of slanted grating 1122 may be less than about 20%, about 11%, about 5%, about 1%, or less.

Different generations of NIL stamps may be made and used as the working stamp to mold the slanted gratings. For example, in some embodiments, a master mold (which may be referred to as a generation 0 mold) may be fabricated (e.g., etched) in, for example, a semiconductor substrate, a quartz, or a metal plate. The master mold may be a hard stamp and may be used as the working stamp to mold the slanted grating directly, which may be referred to as hard stamp ML or hard ML. In such case, the slanted structure on the mold may be complimentary to the desired slanted structure of the slanted grating used as the grating coupler on a waveguide display.

In order to protect the master ML mold, the master ML mold may be fabricated first, and a hybrid stamp (which may be referred to as generation 1 mold or stamp) may then be fabricated using the master ML mold. The hybrid stamp may be used as the working stamp for nanoimprinting. The hybrid stamp may include a hard stamp, a soft stamp, or a hard-soft stamp. Nanoimprinting using a soft stamp may be referred to as soft stamp ML or soft ML. In some embodiments, the hybrid mold may include a plastic backplane with soft or hard patterned polymer (e.g., having a Young's modulus about 1 GPa). In some embodiments, the hybrid mold may include a glass backplane with soft or hard patterned polymer (e.g., having a Young's modulus about 1 GPa). In some embodiments, the hybrid mold may include a glass/plastic laminated backplane with soft or hard patterned polymer. In some embodiments, a generation 2 hybrid mold may be made from the generation 1 mold, and may then be used as the working stamp for the nanoimprinting. In some embodiments, generation 3 hybrid molds, generation 4 hybrid molds, and the like, may be made and used as the working stamp. ML molding may significantly reduce the cost of making the slanted surface-relief structures because the molding process may be much faster than the etching process and no expensive reactive ion etching equipment may be needed.

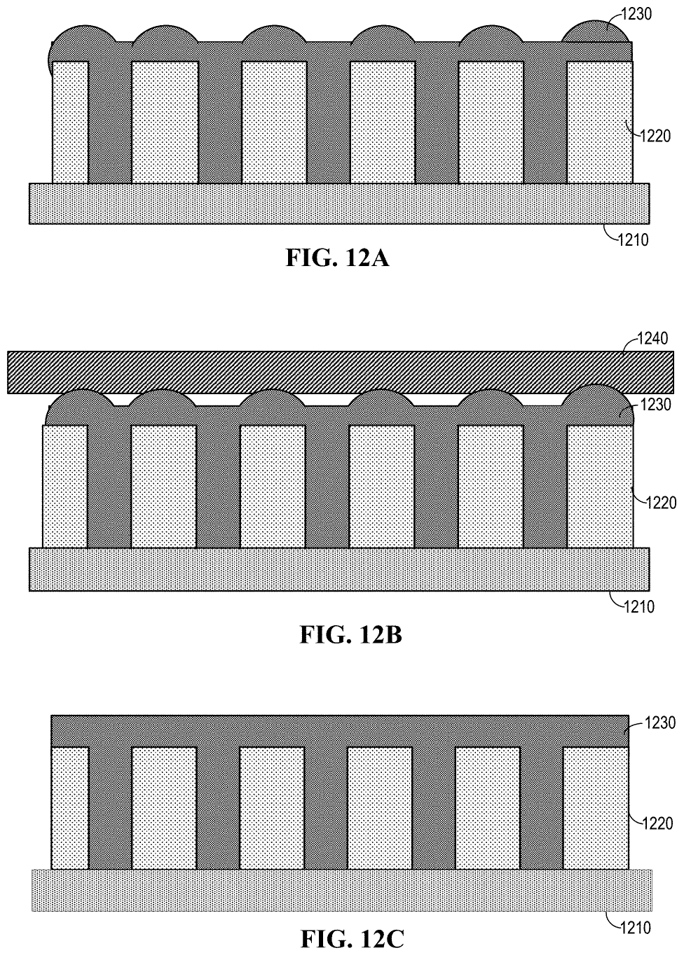

FIGS. 12A-12C illustrate an example of a method of forming a planarized overcoat layer on a surface-relief grating using an imprint process according to certain embodiments. FIG. 12A shows that an overcoat material as described above may be dispensed on a surface-relief grating 1220 on a substrate 1210 to form an overcoat layer 1230. The overcoat material may be dispensed by, for example, by spin-coating or inkjet printing. The amount of overcoat material dispensed on surface-relief grating 1220 may be determined based on the dimensions of the grating grooves and the desired thickness of the overburden (e.g., the portion of the overcoat layer on top of the grating ridges). For example, as described above, it may be desirable that the overburden thickness is less than about 20 nm. After dispensing the overcoat material, the top surface of overcoat layer 1230 may not be flat as shown in the illustrated example. For example, the height of the top surface at the grating ridge regions may be greater than the height of the top surface at the grating groove regions.

In some embodiments, the overcoat layer may optionally be baked to remove the solvent from the overcoat layer. Air trapping (e.g., air bubbles) may occur in the grating grooves when spin-coating techniques are employed. The solvent in the overcoat material may have not completely evaporated. The solvent and/or trapped air may result in a varying refractive index of the overcoat layer and an efficiency loss. The problems may be exacerbated when the grating grooves are relatively deep (e.g., 120 nm, 200 nm, 300 nm, or greater), when the grating grooves are relatively narrow (e.g., gratings with large duty cycles), and/or when the slant angles of the grating ridges are relatively large, such as greater than about 30°, 45°, 50°, 70°, or larger. Baking may help to remove the solvent and the trapped air such that the overcoat material in the overcoat layer may be more uniform or homogeneous.

FIG. 12B shows that a planar imprint stamp 1240 (e.g., a soft stamp or mold described above) may be laminated or otherwise applied on overcoat layer 1230 in an imprint process. As described above, in some embodiments, planar imprint stamp 1240 may include polydimethylsiloxane (PDMS) or another silicone elastomer or silicon-based organic polymer. In some embodiments, planar imprint stamp 1240 may include ethylene tetrafluoroethylene (ETFE), perfluoropolyether (PFPE), or other fluorinated polymer materials. The bottom surface of planar imprint stamp 1240 that contacts overcoat layer 1230 may have a low surface roughness. Planar imprint stamp 1240 may be pressed against overcoat layer 1230, for example, using a roller as described above with respect to, for example, FIG. 12B. Thus, some portions of the overcoat materials on top of the grating ridges may be forced to the regions on top of the grating grooves, and the flat bottom surface of planar imprint stamp 1240 may be transferred to the top surface of overcoat layer 1230.

The overcoat layer may then be cured (e.g., using UV light) to crosslink and fix the base resin in the overcoat material as described above. After the curing and the crosslinking of the overcoat material, the planar imprint stamp may be delaminated or otherwise detached from the overcoat layer and the surface-relief grating, as described above with respect to, for example, FIG. 12C.

FIG. 12C shows that, after the delamination of planar imprint stamp 1240, the top surface of overcoat layer 1230 can be flat and smooth. In addition, the overburden can be very thin, such as less than about 20 nm.

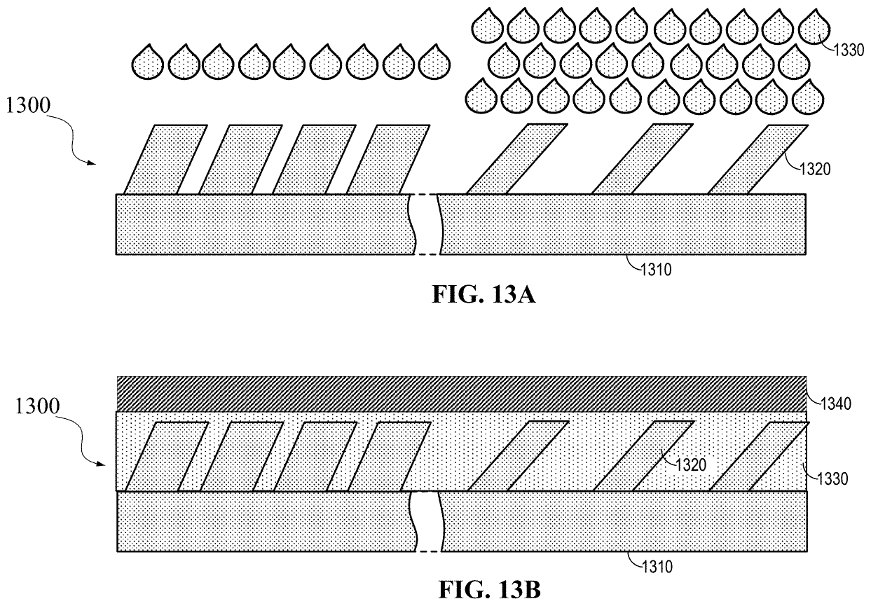

FIGS. 13A-13B illustrate an example of a method of forming a planarized overcoat layer on a surface-relief grating 1300 having variable grating parameters according to certain embodiments. FIG. 13A shows surface-relief grating 1300 including grating ridges 1320 on a substrate 1310 (or a grating material layer or waveguide), where the duty cycle and slant angle of surface-relief grating 1300 may vary from region to region. Inkjet printing or 3-D printing techniques may be used to dispense different amounts of overcoat material 1330 in different regions of surface-relief grating 1300. For example, a larger number of small drops of overcoat material 1330 may be dispensed in regions where the dimensions of the grating grooves are larger, and a smaller number of small drops of overcoat material 1330 may be deposited in regions where the dimensions of the grating grooves are smaller. The amount of overcoat material dispensed may be more precisely controlled by dispensing small drops of overcoat material 1330.

FIG. 13B shows that a planar imprint stamp 1340 may be laminated or otherwise applied on overcoat material 1330, for example, after an optional baking process to remove solvent and/or trapped air. Planar imprint stamp 1340 may be pressed against overcoat material 1330, for example, using a roller as described above with respect to, for example, FIG. 10C. Thus, some portions of the overcoat material 1330 on top of grating ridges 1320 may be forced to the regions on top of the grating grooves, and the flat bottom surface of planar imprint stamp 1340 may be transferred to the top surface of the overcoat layer formed by overcoat material 1330. Overcoat material 1330 may then be cured (e.g., using UV light) to crosslink and fix the base resin as described above. After the curing and the crosslinking of overcoat material 1330, planar imprint stamp 1340 may be delaminated or otherwise detached from the overcoat material layer and the surface-relief grating, as described above with respect to, for example, FIG. 10C. In this way, the top surface of the overcoat layer may be flat. Because the amount of overcoat material dispensed can be more precisely controlled, the thickness of the overburden can be more precisely controlled, and can be very thin, such as less than about 20 nm, less than about 10 nm, or less.

In general, it is desirable to have a large refractive index contrast between the grating ridges and the overcoat layer to improve, for example, the light coupling efficiency, the field-of-view range, and the wavelength range of the near-eye display system. In some surface-relief gratings, the grating ridges may be formed in a high-refractive index material layer (e.g., including a resin and high-refractive index nanoparticles) using nanoimprinting techniques described above with respect to, for example, FIGS. 10A-11D, and an overcoat layer with a low refractive index may be used to achieve the large refractive index contrast. In some surface-relief gratings, the grating ridges may be made of a low-refractive index material (e.g., glass), and an overcoat layer with a high refractive index (e.g., about 2.0 or larger) may be used to achieve the large refractive index contrast. The high-refractive index material for the grating ridges or the overcoat layer may include a resin dispersed with high-refractive index nanoparticles, such as TiO₂ nanoparticles, NbOₓ nanoparticles, and/or ZrO₂ nanoparticles, and the like.

TiO₂ has a higher refractive index (e.g., greater than 2.5 for visible light) than ZrO₂ (e.g., about 2.15 for visible light) and some other dielectric materials (e.g., oxides such as NbOₓ, SiOₓ, TaOₓ, and Al₂O₃), and thus may be mixed with a resin material to form a high-refractive index resin material (e.g., with a refractive index about 2.0 or higher) for nanoimprinting or overcoating. For example, a 200-nm-thick resin layer including 90% by weight (wt. %) of ZrO₂ nanoparticles may have a refractive index about 1.78 for 520-nm light, while a 200-nm-thick resin layer including 90 wt. % of TiO₂ nanoparticles may have a refractive index about 2.05 for 520-nm light.

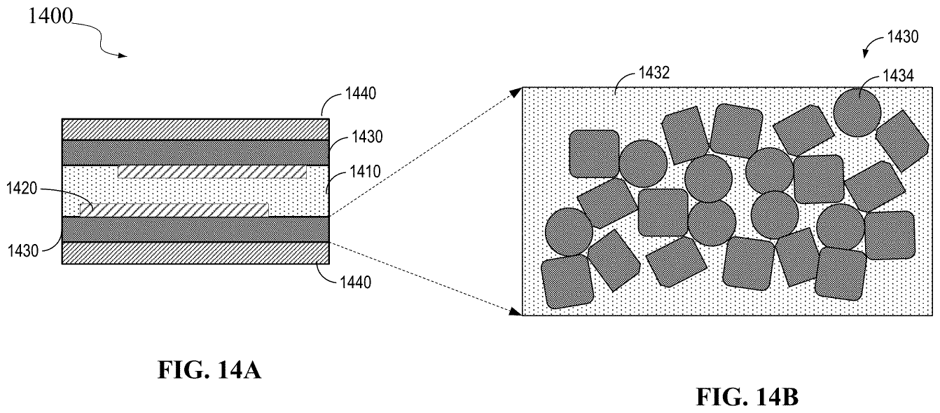

FIG. 14A illustrates an example of a waveguide display 1400 including one or more surface-relief gratings and one or more overcoat layers. In the illustrated example, waveguide display 1400 may include a substrate 1410, such as a glass substrate or a SiC substrate, which may be used as a waveguide to guide display light coupled into substrate 1410, through total internal reflection. One or more surface-relief gratings 1420 may be etched in substrate 1410 or may be formed (e.g., etched or imprinted) in a material layer deposited on substrate 1410. An overcoat layer 1430 may be formed on each surface-relief gratings 1420. The overcoat layer may include high-refractive index metal oxide nanoparticles (e.g., TiO₂, NbOₓ, and/or ZrO₂ nanoparticles) dispersed in a resin. The resin may include, for example, acrylate resin with photo radical generator or thermal radical generator. In one example, the resin may include difunctional high-refractive index monomers. Overcoat layer 1430 may be deposited on a surface-relief grating 1420, baked at an elevated temperature (e.g., about 90° C.), and cured using UV light. In some embodiments, before the curing using UV light, the overcoat layer may be imprinted using a flat stamp as described above with respect to, for example, FIGS. 12A-13B. An antireflective coating (ARC) layers 1440 may be coated on overcoat layers 1430 to reduce Fresnel reflection at the interfaces between waveguide display 1400 and air. In some embodiments, antireflective coating layers 1440 may be baked and/or cured using UV light.

FIG. 14B illustrates an example of an overcoat layer 1430 that includes nanoparticles 1434 (e.g., TiO₂, NbOₓ, or ZrO₂ nanoparticles) and organic materials 1432. After being cured, monomers in overcoat layer 1430 may crosslink to form a crosslinked structure that may fix nanoparticles 1434. Due to its bandgap energy (e.g., about 3.0 to 3.2 eV), TiO₂ nanoparticles may absorb UV light (e.g., with a wavelength λ<388 nm) to excite electrons (e) to the conduction band and leave holes (h⁺) in the valence band. The electrons and holes may migrate to the surface of the nanoparticles to reduce and/or oxidize organic materials 1432 adjacent to nanoparticles 1434. The oxidized and degraded organic materials 1432 may absorb visible light. Therefore, curing overcoat layers 1430 and/or ARC layers 1440 using UV light may degrade the organics in overcoat layers 1430 due to the photocatalytic activity of the metal oxide (e.g., TiO₂) nanoparticles.

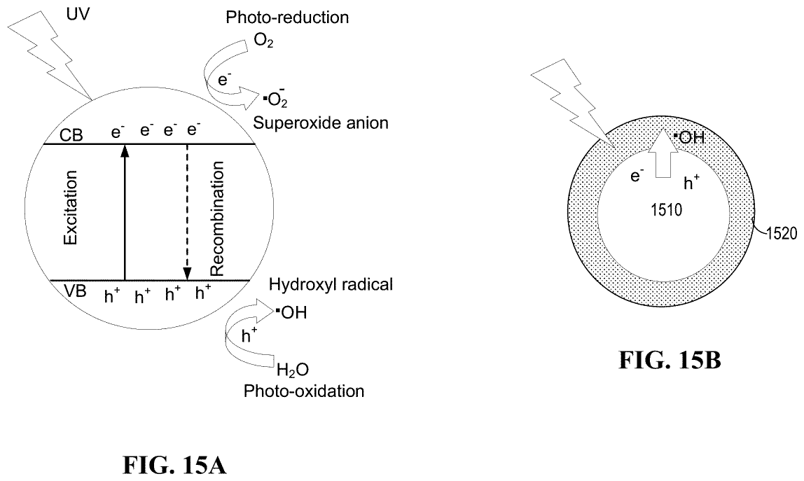

FIG. 15A illustrates an example of the photocatalytic activity of TiO₂ nanoparticles. As illustrated, upon exposure to UV light, electrons in TiO₂ particles may be excited to the conduction band to generate free electrons and holes. Some free electrons and holes may recombine within a short time period to release energy in the form of heat or photons. Some electrons and holes may migrate to the surfaces of the TiO₂ nanoparticles. The photo-produced holes may generate hydroxyl radicals .OH by the oxidation of OH⁻ and/or H₂O molecules that may be absorbed onto the surfaces of TiO₂ nanoparticles. The photo-produced electrons may facilitate the reduction of O₂ molecules absorbed onto the surfaces of TiO₂ nanoparticles to form superoxide radical anions .O₂⁻. These photo-generated hydroxyl radicals and superoxide radicals may in turn oxidize and degrade adjacent organic and/or inorganic materials. These reduction and oxidation reactions shown in FIG. 15A may be used in photocatalytic hydrogen production and photocatalytic water/air purification, respectively. Other metal oxides, such as NbOₓ, which may have a refractive index between about 2.3 and about 2.35, may also be photoactive.

FIG. 15B illustrates an example of organic degradation caused by the photocatalytic activity of TiO₂ nanoparticles 1510. As described above, due to the photoactivity of titanium oxide, TiO₂ nanoparticles 1510 may interact with moisture (H₂O) and/or oxygen (O₂) to generate radicals (e.g., hydroxyl radicals and superoxide radical anions). The hydroxyl radicals may oxidize and degrade organics 1520 (e.g., ligands and resin) adjacent to TiO₂ nanoparticles 1510. These interaction may be triggered via titanium oxide photoexcitation and/or may be thermally induced. TiO₂ nanoparticles 1510, due to their high surface-to-volume ratios, may have a large total surface area and a high light absorption rate, which may increase the surface photo-induced carrier density that can lead to higher surface photoactivity and enhanced photocatalytic activity of TiO₂ nanoparticles. As a result, more organics 1520 may be oxidized and degraded to absorb visible light. Therefore, a film including titanium oxide nanoparticles 1510 and organics 1520 may show some levels of light absorption in the visible spectrum, even though TiO₂ nanoparticles 1510 are transparent to visible light. The absorption of visible light by the film including titanium oxide nanoparticles and organics may increase over time, as the film undergoes further redox interactions with the environment, such as upon further exposure to UV and heat. Therefore, surface-relief gratings or overcoat layers made (e.g., imprinted) using films including titanium oxide nanoparticles and organics may have high absorption and low throughput for waveguide displays.

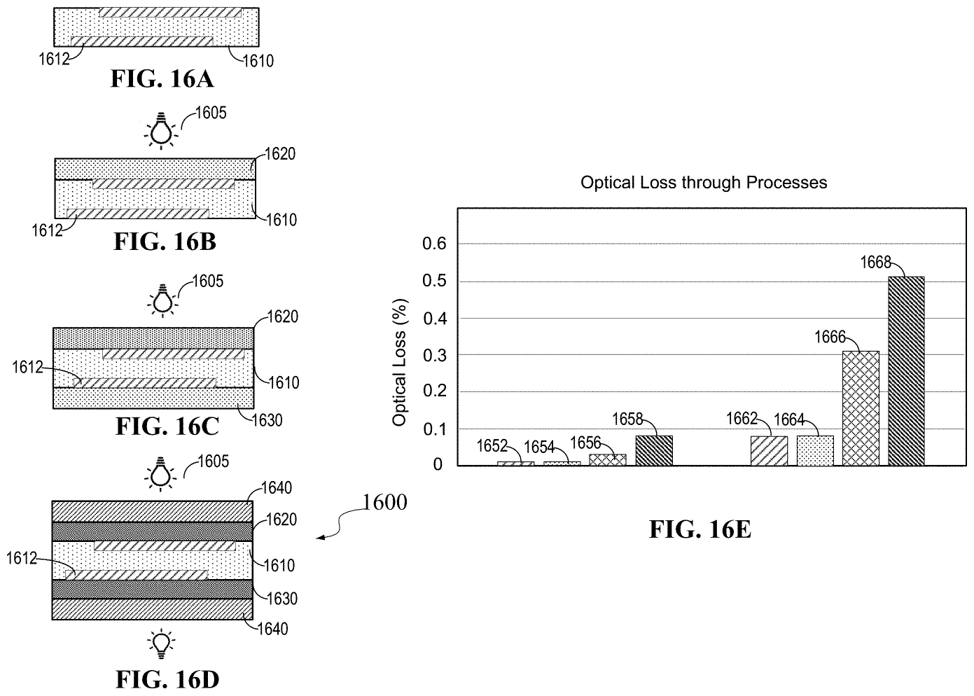

FIGS. 16A-16D illustrate an example of a process of fabricating a waveguide display. FIG. 16A illustrates an example of a substrate 1610 including one or more surface-relief gratings 1612 formed in or on substrate 1610. In some embodiments, surface-relief gratings 1612 may be fabricated by etching substrate 1610 using wet or dry etching techniques, such as ion beam etching. In some embodiments, surface-relief gratings 1612 may be fabricated by depositing a nanoimprint resin layer and imprinting the nanoimprint resin layer using a mold or a soft stamp as described above with respect to, for example, FIGS. 10A-11D. In some embodiments, the nanoimprint resin layer may include high-refractive index metal oxide nanoparticles (e.g., TiO₂, NbOₓ, and/or ZrO₂ nanoparticles) dispersed in a resin. The resin may include, for example, acrylate resin with a photo radical generator or thermal radical generator. The refractive index of the acrylate resin may be between about 1.55 and about 1.7. In one example, the resin may include difunctional high-refractive index monomers.

FIG. 16B illustrates an example of a first overcoat layer 1620 formed on a surface-relief grating 1612 on one side of substrate 1610. In some embodiments, first overcoat layer 1620 may be formed on surface-relief grating 1612 using techniques disclosed above with respect to, for example, FIGS. 12A-13B. In some embodiments, first overcoat layer 1620 may be a nanoimprint resin layer that includes high-refractive index metal oxide nanoparticles (e.g., TiO₂, NbOₓ, and/or ZrO₂ nanoparticles) dispersed in a resin. The resin may include, for example, acrylate resin with photo radical generator or thermal radical generator. The refractive index of the acrylate resin may be between about 1.55 and about 1.7. In one example, the resin may include difunctional high-refractive index monomers. First overcoat layer 1620 may be deposited on surface-relief grating 1612, baked at an elevated temperature (e.g., about 90° C.), and cured using UV light 1605. In some embodiments, before the curing using UV light 1605, the nanoimprint resin layer may be imprinted using a flat stamp as described above with respect to, for example, FIGS. 12A-13B. Curing first overcoat layer 1620 using UV light may degrade the organics in first overcoat layer 1620 due to the photocatalytic activity of the metal oxide (e.g., TiO₂) nanoparticles, as described above with respect to, for example, FIGS. 15A and 15B.

FIG. 16C shows that a second overcoat layer 1630 may be formed on a surface-relief grating 1612 on a second side of substrate 1610. Second overcoat layer 1630 may be formed on surface-relief grating 1612 using techniques disclosed above with respect to, for example, FIGS. 12A-13B. In some embodiments, second overcoat layer 1630 may be a nanoimprint resin layer that includes high-refractive index metal oxide nanoparticles dispersed in a resin as described above with respect to first overcoat layer 1620, where second overcoat layer 1630 may be deposited on surface-relief grating 1612, baked at an elevated temperature (e.g., about 90° C.), and then cured using UV light 1605. In some embodiments, before the curing using UV light 1605, the nanoimprint resin layer may be imprinted using a flat stamp, as described above with respect to, for example, FIGS. 12A-13B and 16B. Curing second overcoat layer 1630 using UV light 1605 may degrade the organics in second overcoat layer 1630 due to the photocatalytic activity of the metal oxide (e.g., TiO₂ or NbOₓ) nanoparticles. Curing second overcoat layer 1630 using UV light 1605 may further expose first overcoat layer 1620 to UV light 1605, and thus may further degrade the organics in first overcoat layer 1620 due to the photocatalytic activity of the metal oxide (e.g., TiO₂ or NbOₓ) nanoparticles exposed to UV light.

FIG. 16D shows that antireflective coating layers 1640 may be coated on first overcoat layer 1620 and second overcoat layer 1630 to form a waveguide display 1600. Antireflective coating layers 1640 may be used to reduce Fresnel reflection at the interfaces between waveguide display 1600 and air. In some embodiments, antireflective coating layers 1640 may be baked and cured using UV light 1605. Curing antireflective coating layers 1640 using UV light 1605 may further expose first overcoat layer 1620 and second overcoat layer 1630 to UV light 1605, and thus may further degrade the organics in first overcoat layer 1620 and second overcoat layer 1630 due to the photocatalytic activity of the metal oxide (e.g., TiO₂) nanoparticles.

FIG. 16E illustrates changes in the optical losses of examples of waveguide displays including surface-relief gratings having different metal oxide nanoparticles during the fabrication processes. As described above, the metal oxide nanoparticles may be photocatalysts that can cause photoactivities upon exposure to light of certain wavelengths. For example, the bandgap energy of TiO₂ may be about 3.0 eV to about 3.2 eV, and may absorb UV light (e.g., with a wavelength λ≤388 nm) to generate free electron-hole pairs that may in turn generate radicals that can react with and degrade adjacent organic or inorganic materials to reduce the transmissivity of the waveguide display. In contrast, the bandgap energy of ZrO₂ may be about 5.0 eV, much higher than that of TiO₂, and thus may only absorb deep UV light. Therefore, a resin layer including ZrO₂ nanoparticles may have a lower level of degradation of the organic materials after UV curing and thermal processing, and thus may have a lower optical loss for visible light.

In one example, the material used to form first overcoat layer 1620 and second overcoat layer 1630 may be a mixture including difunctional high-refractive index monomers such as M1 from TOKYO OHKA KOGYO CO., LTD. (TOK), ZrO₂ nanoparticles, and a solvent, where the ZrO₂ nanoparticles may be about 90 wt. % of the mixture, and the refractive index of first overcoat layer 1620 and second overcoat layer 1630 may be about 1.78. A bar 1652 in FIG. 16E shows the optical loss of an example of the structure shown in FIG. 16B after first overcoat layer 1620 is baked at 90° C. and before first overcoat layer 1620 is cured using UV light, where first overcoat layer 1620 may include ZrO₂ nanoparticles and the thickness of first overcoat layer 1620 may be about 140 nm. A bar 1654 shows the optical loss of the example of the structure shown in FIG. 16B after first overcoat layer 1620 is cured using UV light. A bar 1656 shows the optical loss of an example of the structure shown in FIG. 16C after second overcoat layer 1630 is baked at 90° C. and is cured using UV light, where second overcoat layer 1630 may include ZrO₂ nanoparticles and the thickness of second overcoat layer 1630 may be about 140 nm. A bar 1658 shows the optical loss of waveguide display 1600 shown in FIG. 16D after antireflective coating layers 1640 are baked at 90° C. and are cured using UV light. FIG. 16E shows that the optical losses of the overcoat layers including organics and include ZrO₂ nanoparticles may increase slightly during the fabrication processes.

In another example, the material used to form first overcoat layer 1620 and second overcoat layer 1630 may be a mixture including M1 from TOK, TiO₂ nanoparticles, and a solvent, where the TiO₂ nanoparticles may be about 90 wt. % of the mixture, and the refractive index of first overcoat layer 1620 and second overcoat layer 1630 may be about 2.05. A bar 1662 in FIG. 16E shows the optical loss of an example of the structure shown in FIG. 16B after first overcoat layer 1620 is baked at 90° C. and before first overcoat layer 1620 is cured using UV light, where first overcoat layer 1620 may include TiO₂ nanoparticles and the thickness of first overcoat layer 1620 may be about 140 nm. A bar 1664 shows the optical loss of the example of the structure shown in FIG. 16B after first overcoat layer 1620 is cured using UV light. A bar 1666 shows the optical loss of an example of the structure shown in FIG. 16C after second overcoat layer 1630 is baked at 90° C. and is cured using UV light, where second overcoat layer 1630 may include TiO₂ nanoparticles and the thickness of second overcoat layer 1630 may be about 140 nm. A bar 1668 shows the optical loss of an example of waveguide display 1600 shown in FIG. 16D after antireflective coating layers 1640 are baked at 90° C. and are cured using UV light. FIG. 16E shows that the optical loss of first overcoat layer 1620 and second overcoat layer 1630 may increase significantly during the fabrication processes and can be very high, when TiO₂ nanoparticles are used in the overcoat layers. Thus, it can be difficult to achieve both a high refractive index and a low optical loss for an overcoat layer.

In some implementations, to sequester the photocatalytic activity of the TiO₂ nanoparticles, nanoparticles with metal oxide nanoparticle cores and inorganic shells (referred to as core-shell nanoparticles) may be synthesized and mixed with a resin and/or a solvent to form a high-refractive index resin material for nanoimprinting or overcoating. Each nanoparticle may include an inorganic shell surrounding the nanoparticle core (e.g., a TiO₂ nanoparticle) and isolating the nanoparticle core from organic ligands and/or resin, such that electrons and holes generated by TiO₂ upon exposure to UV light or heat may recombine before the electrons and holes could reach the organic ligands and/or resin to degrade the organic materials.

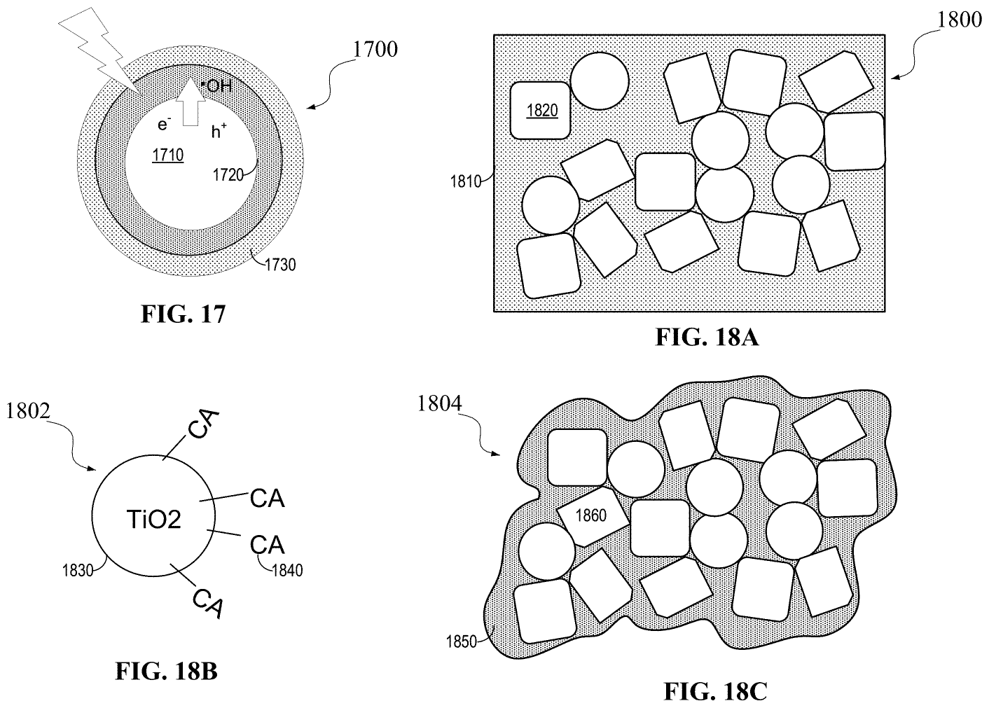

FIG. 17 illustrates an example of a core-shell nanoparticle 1700 including a metal oxide (e.g., TiO₂, NbOₓ, or ZrO₂) nanoparticle core 1710 and an inorganic shell 1720 isolating nanoparticle core 1710 from surrounding organic materials 1730. Electrons and holes generated by metal oxide nanoparticle core 1710 upon exposure to UV light or heat may recombine before the electrons and holes can reach organic materials 1730 to degrade organic materials 1730. Therefore, using core-shell nanoparticles may reduce the optical loss of the surface-relief grating caused by the photocatalytic activity of TiO₂ nanoparticles.

However, it can be challenging to chemically synthesize core-shell nanoparticles with controlled sizes. Multiple synthesis and purification processing steps may generally be needed to make the core-shell nanoparticles, which may increase the cost. For example, the core-shell nanoparticles may be fabricated in two general steps: the preparation/synthesis of the core materials and the synthesis/deposition of the shell layers. In one example, the core materials and shell precursors may be sufficiently mixed (e.g., by solution dispersion, decomposition, mechanical stirring, grinding, and ball-milling) and calcined according to a formula to obtain superfine coated particles. In this process, there may be insufficient contact between the core materials and shell precursors, which may lead to inadequate reactions. High processing temperatures may be needed. Particles with good adhesion or adsorption properties at a certain temperature may be needed.

In another example, the core-shell nanoparticles may be synthesized by liquid phase chemical reactions under a wet environment to deposit modifiers or films on the surfaces of pre-formed particles using, for example, the sol-gel method, hydrolysis method, electrochemical method, hydrothermal method, and/or emulsion polymerization. However, the sol-gel process may take a long time (e.g., several days or even weeks) and there may be micropores in the gels. These liquid phase chemical reaction may have the characteristics of individual self-nucleated shell particles, lack of scalability, the requirement of further purification, and harmful organic solvents.

In yet another example, the core-shell nanoparticles may be synthesized by gas phase chemical reactions, where the shell materials may be deposited on the surfaces of the target particles in a gas phase supersaturated system, for example, using physical vapor deposition (PVD) and chemical vapor deposition (CVD), to form the core-shell nanoparticles. However, some PVD methods may need to be performed at very high temperatures and in vacuums, whereas some CVD methods may have low deposition rate and high equipment requirements and may cause damages to the environment because of the flammable, explosive, or toxic residual gases.

In addition, the dispersibility of chemically synthesized core-shell nanoparticles may be low. The shelf life of chemically synthesized core-shell nanoparticles may be short, and the shell material may nucleate by itself. It may also be challenging to control the shell thickness, which may affect the refractive index, photocatalytic activity, or other properties of the nanoparticles. For example, when the thickness of the shell increases, the reliability and the transparency of the resin material may be improved, but the core-shell nanoparticles may be much larger (e.g., with diameters about 15-20 nm) than the nanoparticle cores (e.g., with diameters about 10-15 nm), and the refractive index of the core-shell nanoparticles may decrease. It may be more difficult to pack, gap-fill, and form smooth surfaces using the larger core-shell nanoparticles.

According to certain embodiments, nanoparticle cores (e.g., TiO₂ or NbOₓ nanoparticles) with inorganic barriers may be formed in situ in a resin material after the deposition of the resin material, rather than being pre-synthesized into core-shell nanoparticles before mixing the core-shell nanoparticles with a resin and a solvent. In one example, metal oxide nanoparticles (e.g., TiO₂, NbOₓ, and/or ZrO₂ nanoparticles) may be dispersed in an inorganic-containing resin (e.g., having high Si, Zr, Nb, Ta, and/or Al content) to form a resin material for imprinting surface-relief gratings or overcoating the surface-relief gratings. In another example, the metal oxide nanoparticles in a resin material may include inorganic-containing capping agents/ligands formed thereon. The resin material including the inorganic-containing resin or the nanoparticles with inorganic-containing capping agents/ligands may be deposited on a substrate or a surface-relief grating, optionally imprinted, crosslinked, and then annealed by, for example, rapid thermal annealing (RTA) or laser spike annealing (LSA), to remove organics in the inorganic-containing capping agents/ligands or the inorganic-containing resin surrounding the nanoparticles, and form inorganic barriers that surround each cluster of nanoparticles to isolate the nanoparticles from organic materials and other materials in the resin material or the environment, thereby sequestering the photocatalytic activity of the TiO₂ nanoparticles.

FIG. 18A illustrates an example of a resin material 1800 including inorganic-containing resin 1810 and TiOₓ nanoparticles 1820 dispersed in inorganic-containing resin 1810 according to certain embodiments. Inorganic-containing resin 1810 may include an organic solvent and an organic solvent soluble resin with high Si, Zr, Nb, Ta, and/or Al content. TiOₓ nanoparticles 1820 may be mixed with the organic solvent soluble resin and the organic solvent to form resin material 1800. The organic solvent may include, for example, propylene glycol methyl ether acetate (PGMEA) (for spin-on coating), dipropylene glycol methyl ether (DPGME)/tripropylene glycol monomethyl ether (TPM) (for inkjet coating), or a solvent blend including one or more solvents that may or may not have boiling points greater than 200° C. The organic solvent soluble resin may include, for example, acrylate, polystyrenics, epoxy, siloxane, or silane-containing resin with a photo radical generator or thermal radical generator. TiOₓ nanoparticles 1820 may be about 75% by weight to about 90% by weight of the resin material. The sizes (e.g., diameters or widths) of TiOₓ nanoparticles 1820 may be, for example, about 10-15 nm.

In another example, a resin material may include an organic solvent soluble resin, such as siloxane or silane-containing resin with photo radical generator or thermal radical generator and having a refractive index between about 1.55 and about 1.7. The resin material may also include about 75% to about 90% of TiOₓ nanoparticles decorated with Si, Zr, Nb, Ta, and/or Al containing capping agents and/or functionalized ligands. The resin material may include a solvent such as PGMEA (for spin-on coating), DPGME/TPM (for inkjet coating), or a solvent blend including one or more solvents that may or may not have boiling points greater than 200° C.

FIG. 18B illustrates an example of a nanoparticle 1802 including a TiO₂ nanoparticle core 1830 and inorganic-containing capping agents 1840 according to certain embodiments. As described above, TiO₂ nanoparticle core 1830 may have a diameter of, for example, about 10-15 nm. Capping agents 1840 (also referred to as capping ligands) may cap the surface of TiO₂ nanoparticle core 1830 by donating lone-pair electrons to the surface metal atoms of TiO₂ nanoparticle core 1830. Capping agents 1840 may include, for example, amphiphilic molecules each comprising a polar head group and a non-polar hydrocarbon tail. Capping agents 1840 may include organic components and may also include inorganic materials such as Si, Zr, Nb, Ta, and Al. Capping agents 1840 may be used to control the size, morphology, and monodispersity of the nanoparticles. For example, capping agents 1840 may be used to stabilize the interface where TiO₂ nanoparticle core 1830 interacts with it medium of preparation, and may inhibit the over-growth of nanoparticles and prevent their aggregation/coagulation during synthesis. As described above, nanoparticle 1802 may be mixed with an organic solvent soluble resin and an organic solvent to form a resin material that may be used to form inorganic barriers for clusters of nanoparticles in situ.

FIG. 18C illustrates an example of an annealed resin material 1804 including inorganic barriers 1850 surrounding clusters of nanoparticles 1860 according to certain embodiments. The resin material may be the resin material described above with respect to FIG. 18A or 18B. The resin material may be deposited and then crosslinked using UV light or heat, such that nanoparticles 1860 may be fixed by the crosslinked structure. The crosslinked resin material may then be annealed by RTA, LSA, or other high-energy treatment process, to remove organics in the inorganic-containing capping agents or the inorganic-containing resin surrounding nanoparticles 1860. Because the resin material has been crosslinked before the annealing, the packing of nanoparticles 1860 may not be changed by the annealing. The annealing and the removal of the organics (e.g., in capping agents or ligands) adjacent to nanoparticles 1860 may cause the formation of inorganic barriers 1850 that surround clusters of nanoparticles 1860 to isolate nanoparticles 1860 from remaining organics (e.g., crosslinked resin), thereby sequestering the photocatalytic activity of the TiO₂ nanoparticles described above.

As shown in FIG. 18C, each cluster of nanoparticles surround by an inorganic barrier 1850 may include two or more nanoparticles 1860. Nanoparticles 1860 in a cluster may not have individual shells to form individual core-shell nanoparticles, but may share a common inorganic barrier 1850. For example, nanoparticles 1860 in a cluster may be dispersed in a common inorganic barrier 1850, such that inorganic barrier 1850 may isolate nanoparticles 1860 from organic materials, moisture, and/or oxygen, to sequester the photocatalytic activity of nanoparticles 1860. As shown in FIG. 18C, some nanoparticles 1860 in a cluster of nanoparticles may physically contact one another.

Compared with chemically synthesized core-shell nanoparticles that may have larger sizes, nanoparticles with inorganic barriers formed in situ may achieve a better packing of nanoparticles, and thus may achieve higher refractive indices, better gap fill, and lower surface roughness. The thickness of the inorganic barrier may be tuned by, for example, tuning the type of capping agents or resin. Current commercially available nanoparticle cores may be used, and the cost of the nanoparticles with inorganic barriers formed in situ may be much lower than chemically synthesized core-shell nanoparticles.

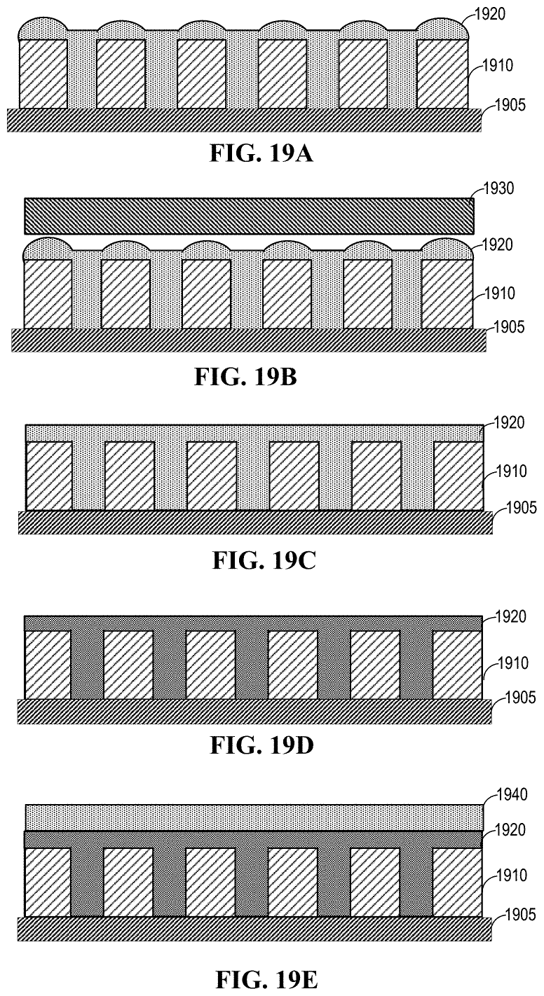

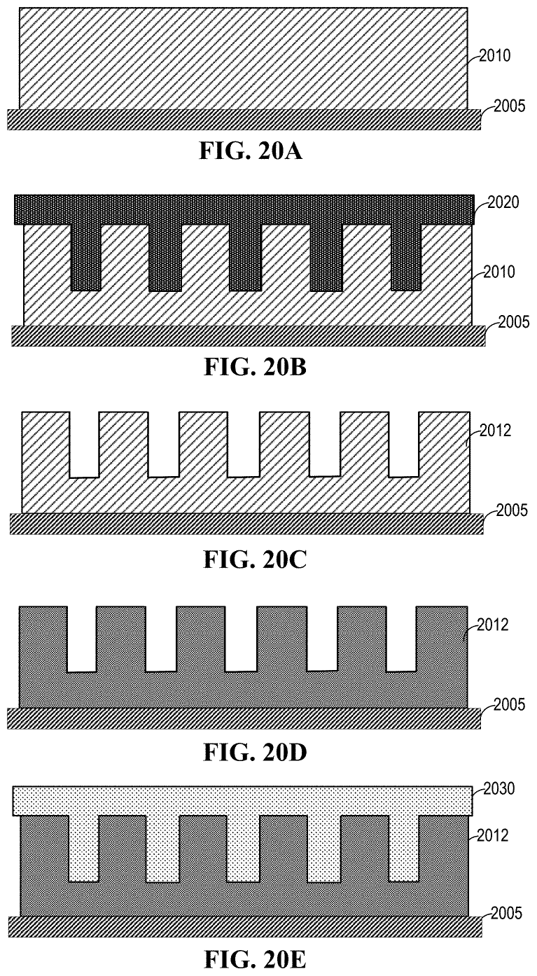

FIGS. 19A-19E illustrate an example of a process of fabricating a surface-relief grating including an overcoat layer having a high refractive index and a low loss using the resin material disclosed herein according to certain embodiments. FIG. 19A shows that a resin material may be dispensed on a surface-relief grating 1910 on a substrate 1905 to form an overcoat layer 1920 for surface-relief grating 1910. As described above, the resin material may include a resin, nanoparticles (e.g., TiO₂ nanoparticles), and a solvent (e.g., PGMEA, DPGME/TPM, or a solvent blend). The resin may include, for example, acrylate, polystyrenics, epoxy, siloxane, or silane-containing resin with a photo radical generator or thermal radical generator. In some embodiments, the resin in the resin material may include high Si, Zr, Nb, Ta, and/or Al content. In some embodiments, the nanoparticles may be decorated with Si, Zr, Nb, Ta, and/or Al containing capping agents and/or functionalized ligands. The resin material may have a high refractive index (e.g., greater than about 1.8, 1.9, or 1.95) due to the packing of the high-refractive index metal oxide nanoparticles. The resin material may be dispensed by, for example, spin coating or inkjet printing. The amount of the resin material dispensed on surface-relief grating 1910 may be determined based on the dimensions of the grating grooves and the desired thickness of the overburden (e.g., the portion of the overcoat layer on top of the grating ridges). After dispensing the resin material, the top surface of overcoat layer 1920 may not be flat as shown in the illustrated example. For example, the height of the top surface at the grating ridge regions may be greater than the height of the top surface at the grating groove regions. In some embodiments, overcoat layer 1920 may be baked to remove the solvent from the overcoat layer. Baking may help to remove the solvent and the trapped air such that the resin material in the overcoat layer may be more uniform or homogeneous.

FIG. 19B shows that a planar imprint stamp 1930 (e.g., a soft stamp or mold described above) may be laminated or otherwise applied on overcoat layer 1920 in an imprint process. As described above, in some embodiments, planar imprint stamp 1930 may include PDMS or another silicone elastomer or silicon-based organic polymer. In some embodiments, planar imprint stamp 1930 may include ETFE, PFPE, or other fluorinated polymer materials. The bottom surface of planar imprint stamp 1930 that contacts overcoat layer 1920 may have a low surface roughness. Planar imprint stamp 1930 may be pressed against overcoat layer 1920, for example, using a roller as described above with respect to, for example, FIG. 11B. Thus, some portions of the resin materials on top of the grating ridges may be forced to the regions on top of the grating grooves, and the flat bottom surface of planar imprint stamp 1930 may be transferred to the top surface of overcoat layer 1920.

FIG. 19C shows that overcoat layer 1920 may then be cured (e.g., using UV light) to crosslink and fix the base resin in the resin material as described above. After the curing and the crosslinking of the resin material, planar imprint stamp 1930 may be delaminated or otherwise detached from overcoat layer 1920 and surface-relief grating 1910, as described above with respect to, for example, FIG. 11C. After the delamination of planar imprint stamp 1930, the top surface of overcoat layer 1920 can be flat and smooth. In addition, the overburden can be thin, such as less than about 20 nm.

FIG. 19D shows that an annealing process (e.g., RTA or LSA) may be performed on overcoat layer 1920 to remove the organic materials (e.g., organic ligands that decorate the TiO₂ nanoparticles) in overcoat layer 1920. After the annealing and the removal of the organics in the inorganic-containing capping agents or the inorganic-containing resin surrounding nanoparticles 1860, inorganic barriers that include no organic materials and surround clusters of nanoparticles may be formed as described above with respect to FIG. 18C. The inorganic barriers may isolate the nanoparticles from remaining organic material (e.g., crosslinked resin) in the overcoat layer, thereby sequestering the photocatalytic activity of the TiO₂ nanoparticles described above.

FIG. 19E shows that an antireflective coating (ARC) layer 1940 may be deposited on overcoat layer 1920. ARC layer 1940 may include organic and/or inorganic materials. Depositing ARC layer 1940 may include an inkjet coating process, a spin coating process, an ALD process, a PVD process, an CVD process, or a combination thereof. ARC layer 1940 may be used to reduce Fresnel reflection at the interface between the waveguide display and air, and thus may help to reduce ghost images, rainbow artifacts, and other artifacts of the waveguide display.

FIGS. 20A-20E illustrate an example of a process of fabricating a surface-relief grating including grating ridges having a high refractive index and a low loss according to certain embodiments. FIG. 20A shows that a uniform layer of a resin material 2010 may be dispensed on a substrate 2005. As described above, resin material 2010 may include a resin, nanoparticles (e.g., TiO₂, NbOₓ, and/or ZrO₂ nanoparticles), and a solvent (e.g., PGMEA, DPGME/TPM, or a solvent blend). The resin may include, for example, acrylate, polystyrenics, epoxy, siloxane, or silane-containing resin with a photo radical generator or thermal radical generator. In some embodiments, the resin in resin material 2010 may include high Si, Zr, Nb, Ta, and/or Al content. In some embodiments, the nanoparticles may be decorated with Si, Zr, Nb, Ta, and/or Al containing capping agents and/or functionalized ligands. Resin material 2010 may have a high refractive index (e.g., greater than about 1.8, 1.9, or 1.95) due to the packing of the high-refractive index metal oxide nanoparticles. The uniform layer of resin material 2010 may be dispensed by, for example, spin coating or inkjet printing. In some embodiments, resin material 2010 may be baked to remove the solvent. Baking may help to remove the solvent and the trapped air such that resin material 2010 may be more uniform or homogeneous.

FIG. 20B shows that an imprint stamp 2020 (e.g., a soft stamp) may be laminated or otherwise applied on resin material 2010 in an imprint process. As described above, in some embodiments, imprint stamp 2020 may include PDMS or another silicone elastomer or silicon-based organic polymer. In some embodiments, imprint stamp 2020 may include ETFE, PFPE, or other fluorinated polymer materials. The surfaces of imprint stamp 2020 that contacts resin material 2010 may have surface-relief structures. Imprint stamp 2020 may be pressed against resin material 2010, for example, using a roller as described above with respect to, for example, FIG. 11B. Thus, the surface-relief structures in imprint stamp 2020 may be transferred to resin material 2010 such that surface-relief structures complementary to the surface-relief structures in imprint stamp 2020 may be formed in resin material 2010.

FIG. 20C shows that resin material 2010 may be cured (e.g., using UV light) to crosslink and fix the base resin in the resin material as described above. After the curing and the crosslinking of resin material 2010, imprint stamp 2020 may be delaminated or otherwise detached from resin material 2010, thereby forming surface-relief grating 2012 in resin material 20100 as described above with respect to, for example, FIG. 11C. Even though the example of surface-relief grating 2012 shown in FIG. 20C includes straight grating ridges, in some embodiments, surface-relief grating 2012 may include slanted grating ridges. The grating period, duty cycle, and/or depth of surface-relief grating 2012 may be constant or may be variable across the grating.

FIG. 20D shows that an annealing process (e.g., RTA or LSA) may be performed on surface-relief grating 2012 to remove the organic materials (e.g., organic ligands that decorate TiO₂ nanoparticles) in surface-relief grating 2012. After the annealing and the removal of the organics in the inorganic-containing capping agents or the inorganic-containing resin that surrounds the nanoparticles, inorganic barriers that include no organic materials and surround clusters of nanoparticles may be formed as described above with respect to FIG. 18C. The inorganic barriers may isolate the nanoparticles from remaining organic materials (e.g., crosslinked resin) and other materials in surface-relief grating 2012 and the environment, thereby sequestering the photocatalytic activity of the TiO₂ nanoparticles described above. Therefore, grating ridges in surface-relief grating 2012 may have a high refractive index and a low optical loss.

FIG. 20E shows that an overcoat layer 2030 may be deposited on surface-relief grating 2012. As described above, overcoat layer 2030 may include organic and/or inorganic materials. The organic and/or inorganic materials may have a low optical loss, and may have a refractive index lower than a refractive index of the ridges of surface-relief grating 2012, such that surface-relief grating 2012 may have a high refractive index contrast between grating ridges and grating grooves. In some embodiments, an ARC layer may be deposited on overcoat layer 2030, to reduce Fresnel reflection at the interface between the grating and air, and thus may help to reduce ghost images, rainbow artifacts, and other artifacts of a waveguide display. The ARC layer may include organic and/or inorganic materials. Depositing the ARC layer may include an inkjet coating process, a spin coating process, an ALD process, a PVD process, an CVD process, or a combination thereof.

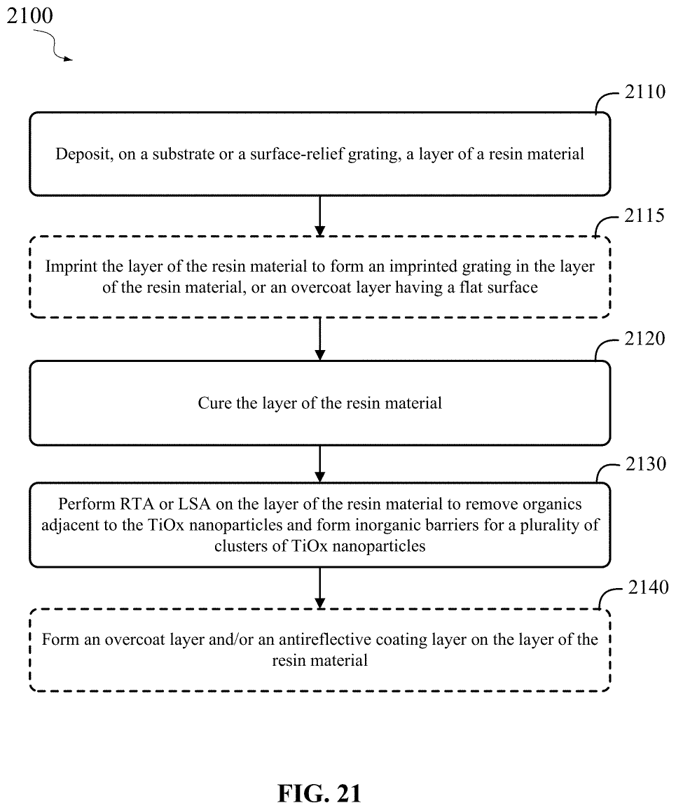

FIG. 21 includes a flowchart 2100 illustrating an example of a process of fabricating a surface-relief grating that has a high refractive index contrast and a low loss according to certain embodiments. It is noted that the specific operations illustrated in FIG. 21 provide a particular process of fabricating a surface-relief grating. Other sequences of operations may be performed according to alternative embodiments. Moreover, the individual operations illustrated in FIG. 21 may include multiple sub-steps that may be performed in various sequences as appropriate to the individual operation. Furthermore, additional operations may be added or some operations may not be performed depending on the particular applications. One of ordinary skill in the art would recognize many variations, modifications, and alternatives.

Operations in block 2110 may include depositing, on a substrate or a surface-relief grating, a layer of a resin material. As described above, the layer of the resin material may include a resin, nanoparticles (e.g., TiO₂, NbOₓ, and/or ZrO₂ nanoparticles), and a solvent (e.g., PGMEA, DPGME/TPM, or a solvent blend). The resin may include, for example, an organic solvent soluble resin including acrylate, polystyrenics, epoxy, siloxane, silane, or a combination thereof. In some embodiments, the resin may include a photo radical generator or thermal radical generator. In some embodiments, the resin may include high Si, Zr, Nb, Al, and/or Ta content. In some embodiments, the TiOₓ nanoparticles may be decorated with Si, Zr, Nb, Al, and/or Ta containing capping agents and/or functionalized ligands. In some embodiments, the TiOₓ nanoparticles may be about 75% by weight to about 90% by weight in the resin material. The resin material may have a high refractive index (e.g., greater than about 1.8, 1.9, or 1.95) due to the packing of the high-refractive index metal oxide nanoparticles such as TiOₓ nanoparticles. The layer of the resin material may be deposited on the substrate or the surface-relief grating using spin coating, inkjet coating, or spray coating. In some embodiments, the layer of the resin material may be baked to remove the solvent. Baking may help to remove the solvent and the trapped air such that the material in the layer of the resin material may be more uniform or homogeneous.

Optional operations in block 2115 may include imprinting the layer of the resin material by, for example, laminating a planar imprint stamp or an imprint stamp with structures complementary to the structures of a surface-relief grating on the layer of the resin material. As described above, the imprint stamp may include PDMS or another silicone elastomer or silicon-based organic polymer. In some embodiments, the imprint stamp may include ETFE, PFPE, or other fluorinated polymer materials. The planar imprint stamp may be used to form an overcoat layer with a flat top surface. The imprint stamp with structures complementary to the structures of a surface-relief grating may be used to form the surface-relief grating in the layer of the resin material.

Operations in block 2120 may include curing (e.g., using UV light or heat) the layer of the resin material to crosslink the resin in the layer of the resin material. The crosslinked base resin may hold the TiOₓ nanoparticles in place. After the curing, the imprint stamp (if used) may be delaminated from the layer of the resin material to leave a flat top surface (for an overcoat layer) on the layer of the resin material or an imprinted surface-relief grating in the layer of the resin material.

Operations in block 2130 may include performing rapid thermal annealing (RTA) or laser spike annealing (LSA) on the layer of the resin material to remove organics adjacent to the TiOₓ nanoparticles and form inorganic barriers for a plurality of clusters of TiOₓ nanoparticles, where the inorganic barriers isolate each cluster of TiOₓ nanoparticles of the plurality of clusters of TiOₓ nanoparticles from other materials in the layer of the resin material and materials in the environment (e.g., water or oxygen). For example, the inorganic barriers may isolate the nanoparticles in each cluster of TiOₓ nanoparticles from remaining organic material (e.g., crosslinked resin) in the layer of the resin material, thereby sequestering the photocatalytic activity of the TiOₓ nanoparticles described above.

Optional operations in block 2140 may include forming an overcoat layer and/or an antireflective coating layer on the layer of the resin material. As described above, the overcoat layer may include organic and/or inorganic materials. The organic and/or inorganic materials may have a low optical loss, and may have a refractive index lower than a refractive index of the ridges of the surface-relief grating, such that the surface-relief grating may have a high refractive index contrast between grating ridges and grating grooves. In some embodiments, an ARC layer may be deposited on the overcoat layer, to reduce Fresnel reflection at the interface between the surface-relief grating and air, and thus may help to reduce ghost images, rainbow artifacts, and other optical artifacts of a waveguide display. The ARC layer may include organic and/or inorganic materials. Depositing the ARC layer may include an inkjet coating process, a spin coating process, an ALD process, a PVD process, an CVD process, or a combination thereof.

Embodiments of the invention may include or be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

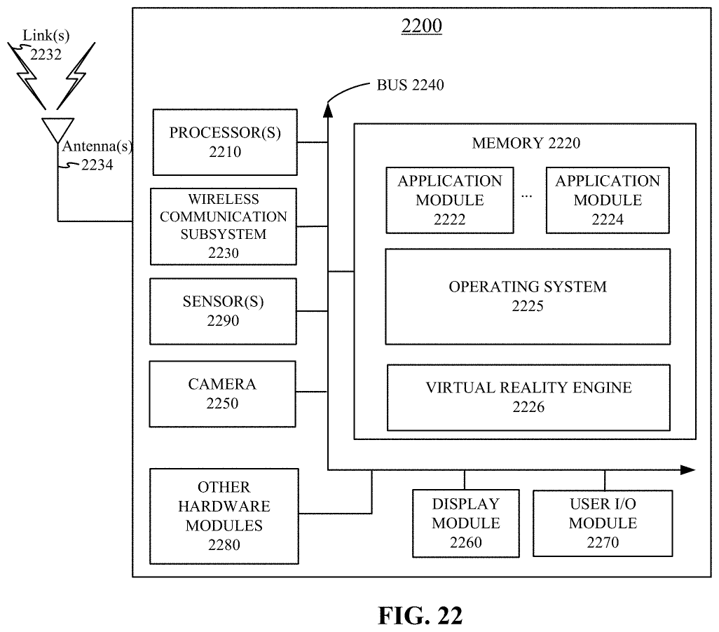

FIG. 22 is a simplified block diagram of an example electronic system 2200 of an example near-eye display (e.g., HMD device) for implementing some of the examples disclosed herein. Electronic system 2200 may be used as the electronic system of an HMD device or other near-eye displays described above. In this example, electronic system 2200 may include one or more processor(s) 2210 and a memory 2220. Processor(s) 2210 may be configured to execute instructions for performing operations at a number of components, and can be, for example, a general-purpose processor or microprocessor suitable for implementation within a portable electronic device. Processor(s) 2210 may be communicatively coupled with a plurality of components within electronic system 2200. To realize this communicative coupling, processor(s) 2210 may communicate with the other illustrated components across a bus 2240. Bus 2240 may be any subsystem adapted to transfer data within electronic system 2200. Bus 2240 may include a plurality of computer buses and additional circuitry to transfer data.

Memory 2220 may be coupled to processor(s) 2210. In some embodiments, memory 2220 may offer both short-term and long-term storage and may be divided into several units. Memory 2220 may be volatile, such as static random access memory (SRAM) and/or dynamic random access memory (DRAM) and/or non-volatile, such as read-only memory (ROM), flash memory, and the like. Furthermore, memory 2220 may include removable storage devices, such as secure digital (SD) cards. Memory 2220 may provide storage of computer-readable instructions, data structures, program modules, and other data for electronic system 2200. In some embodiments, memory 2220 may be distributed into different hardware modules. A set of instructions and/or code might be stored on memory 2220. The instructions might take the form of executable code that may be executable by electronic system 2200, and/or might take the form of source and/or installable code, which, upon compilation and/or installation on electronic system 2200 (e.g., using any of a variety of generally available compilers, installation programs, compression/decompression utilities, etc.), may take the form of executable code.

In some embodiments, memory 2220 may store a plurality of application modules 2222 through 2224, which may include any number of applications. Examples of applications may include gaming applications, conferencing applications, video playback applications, or other suitable applications. The applications may include a depth sensing function or eye tracking function. Application modules 2222-2224 may include particular instructions to be executed by processor(s) 2210. In some embodiments, certain applications or parts of application modules 2222-2224 may be executable by other hardware modules 2280. In certain embodiments, memory 2220 may additionally include secure memory, which may include additional security controls to prevent copying or other unauthorized access to secure information.

In some embodiments, memory 2220 may include an operating system 2225 loaded therein. Operating system 2225 may be operable to initiate the execution of the instructions provided by application modules 2222-2224 and/or manage other hardware modules 2280 as well as interfaces with a wireless communication subsystem 2230 which may include one or more wireless transceivers. Operating system 2225 may be adapted to perform other operations across the components of electronic system 2200 including threading, resource management, data storage control and other similar functionality.

Wireless communication subsystem 2230 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 2200 may include one or more antennas 2234 for wireless communication as part of wireless communication subsystem 2230 or as a separate component coupled to any portion of the system. Depending on desired functionality, wireless communication subsystem 2230 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 2230 may permit data to be exchanged with a network, other computer systems, and/or any other devices described herein. Wireless communication subsystem 2230 may include a means for transmitting or receiving data, such as identifiers of HMD devices, position data, a geographic map, a heat map, photos, or videos, using antenna(s) 2234 and wireless link(s) 2232.

Embodiments of electronic system 2200 may also include one or more sensors 2290. Sensor(s) 2290 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor. For example, in some implementations, sensor(s) 2290 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 2200 may include a display module 2260. Display module 2260 may be a near-eye display, and may graphically present information, such as images, videos, and various instructions, from electronic system 2200 to a user. Such information may be derived from one or more application modules 2222-2224, virtual reality engine 2226, one or more other hardware modules 2280, a combination thereof, or any other suitable means for resolving graphical content for the user (e.g., by operating system 2225). Display module 2260 may use liquid crystal display (LCD) technology, light-emitting diode (LED) technology (including, for example, OLED, ILED, μLED, AMOLED, TOLED, etc.), light emitting polymer display (LPD) technology, or some other display technology.

Electronic system 2200 may include a user input/output module 2270. User input/output module 2270 may allow a user to send action requests to electronic system 2200. An action request may be a request to perform a particular action. For example, an action request may be to start or end an application or to perform a particular action within the application. User input/output module 2270 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 2200. In some embodiments, user input/output module 2270 may provide haptic feedback to the user in accordance with instructions received from electronic system 2200. For example, the haptic feedback may be provided when an action request is received or has been performed.

Electronic system 2200 may include a camera 2250 that may be used to take photos or videos of a user, for example, for tracking the user's eye position. Camera 2250 may also be used to take photos or videos of the environment, for example, for VR, AR, or MR applications. Camera 2250 may include, for example, a complementary metal-oxide-semiconductor (CMOS) image sensor with a few millions or tens of millions of pixels. In some implementations, camera 2250 may include two or more cameras that may be used to capture 3-D images.

In some embodiments, electronic system 2200 may include a plurality of other hardware modules 2280. Each of other hardware modules 2280 may be a physical module within electronic system 2200. While each of other hardware modules 2280 may be permanently configured as a structure, some of other hardware modules 2280 may be temporarily configured to perform specific functions or temporarily activated. Examples of other hardware modules 2280 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 2280 may be implemented in software.

In some embodiments, memory 2220 of electronic system 2200 may also store a virtual reality engine 2226. Virtual reality engine 2226 may execute applications within electronic system 2200 and receive position information, acceleration information, velocity information, predicted future positions, or some combination thereof of the HMD device from the various sensors. In some embodiments, the information received by virtual reality engine 2226 may be used for producing a signal (e.g., display instructions) to display module 2260. For example, if the received information indicates that the user has looked to the left, virtual reality engine 2226 may generate content for the HMD device that mirrors the user's movement in a virtual environment. Additionally, virtual reality engine 2226 may perform an action within an application in response to an action request received from user input/output module 2270 and provide feedback to the user. The provided feedback may be visual, audible, or haptic feedback. In some implementations, processor(s) 2210 may include one or more GPUs that may execute virtual reality engine 2226.

In various implementations, the above-described hardware and modules may be implemented on a single device or on multiple devices that can communicate with one another using wired or wireless connections. For example, in some implementations, some components or modules, such as GPUs, virtual reality engine 2226, and applications (e.g., tracking application), may be implemented on a console separate from the head-mounted display device. In some implementations, one console may be connected to or support more than one HMD.

In alternative configurations, different and/or additional components may be included in electronic system 2200. Similarly, functionality of one or more of the components can be distributed among the components in a manner different from the manner described above. For example, in some embodiments, electronic system 2200 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC, AA, ABC, AAB, ACC, AABBCCC, or the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. An optical device comprising:
a substrate;
a surface-relief grating including grooves and ridges formed on or in the substrate; and
an overcoat layer in the grooves of the surface-relief grating,
wherein the ridges of the surface-relief grating or the overcoat layer comprises a plurality of clusters of metal oxide nanoparticles, and
wherein each cluster of the plurality of clusters of metal oxide nanoparticles includes TiO₂ or NbOₓ nanoparticles dispersed in an inorganic barrier that isolates the TiO₂ or NbOₓ nanoparticles from other materials of the optical device.

2. The optical device of claim 1, wherein the inorganic barrier includes Al₂O₃, SiO₂, ZrO₂, Nb₂O₅, Ta₂O₅, or a combination thereof.

3. The optical device of claim 1, wherein the ridges of the surface-relief grating or the overcoat layer is characterized by a refractive index greater than 1.9 for visible light.

4. The optical device of claim 1, wherein a total optical absorption of the surface-relief grating and the overcoat layer is lower than 0.1% for visible light.

5. The optical device of claim 1, wherein metal oxide nanoparticles of the plurality of clusters of metal oxide nanoparticles are characterized by linear dimensions less than 16 nm.

6. The optical device of claim 1, wherein the other materials of the optical device include organic materials.

7. The optical device of claim 1, wherein a cluster of the plurality of clusters of metal oxide nanoparticles includes at least two metal oxide nanoparticles physically contacting each other.

8. The optical device of claim 1, wherein:
the substrate includes a waveguide; and
the surface-relief grating is configured to couple visible light into or out of the waveguide.

9. A resin material comprising:
an organic solvent;
an organic solvent soluble resin; and
TiOₓ or NbOₓ nanoparticles,
wherein:
the organic solvent soluble resin includes inorganic content,
the TiOₓ or NbOₓ nanoparticles include inorganic-containing ligands, or
both the organic solvent soluble resin includes inorganic content and the TiOₓ or NbOₓ nanoparticles include inorganic-containing ligands.

10. The resin material of claim 9, wherein the organic solvent includes propylene glycol methyl ether acetate (PGMEA), dipropylene glycol methyl ether (DPGME)/tripropylene glycol monomethyl ether (TPM), or a solvent blend.

11. The resin material of claim 9, wherein the organic solvent soluble resin includes acrylate, polystyrenics, epoxy, siloxane, silane, or a combination thereof.

12. The resin material of claim 9, wherein the inorganic content of the organic solvent soluble resin includes Si, Zr, Nb, Al, Ta, or a combination thereof.

13. The resin material of claim 9, further comprising a photo radical generator or thermal radical generator.

14. The resin material of claim 9, wherein the inorganic-containing ligands include a capping agent or a functionalized ligand, and include Si, Zr, Nb, Al, Ta, or a combination thereof.

15. The resin material of claim 9, wherein the resin material includes 75% by weight to 90% by weight of TiOₓ nanoparticles.

16. A method comprising:
depositing, on a substrate or a surface-relief grating, a layer of a resin material that includes:
an organic solvent;
a resin soluble in the organic solvent; and
metal oxide nanoparticles including TiOₓ or NbOₓ nanoparticles,
wherein the resin includes inorganic content, the metal oxide nanoparticles include inorganic-containing ligands, or both the resin includes inorganic content and the metal oxide nanoparticles include inorganic-containing ligands;
curing the layer of the resin material using ultraviolet light or heat to crosslink the resin; and
performing rapid thermal annealing (RTA) or laser spike annealing (LSA) on the layer of the resin material to remove organics adjacent to the metal oxide nanoparticles and form inorganic barriers for a plurality of clusters of metal oxide nanoparticles, the inorganic barriers isolating each cluster of metal oxide nanoparticles of the plurality of clusters of metal oxide nanoparticles from other materials in the layer of the resin material.

17. The method of claim 16, wherein the organic solvent includes propylene glycol methyl ether acetate (PGMEA), dipropylene glycol methyl ether (DPGME)/tripropylene glycol monomethyl ether (TPM), or a solvent blend.

18. The method of claim 16, wherein:
the inorganic content of the resin includes Si, Zr, Nb, Al, Ta, or a combination thereof; and
the inorganic-containing ligands of the metal oxide nanoparticles include a capping agent or a functionalized ligand that includes Si, Zr, Nb, Al, Ta, or a combination thereof.

19. The method of claim 16, wherein the resin includes acrylate, polystyrenics, epoxy, siloxane, silane, or a combination thereof.

20. The method of claim 16, further comprising imprinting, before the curing, the layer of the resin material to form:
an imprinted grating in the layer of the resin material; or
an overcoat layer having a flat surface.
